(19) United States
(12) Patent Application Publication
(10) Pub. No.: US 2023/0383219 A1
(43) Pub. Date: Nov. 30, 2023

(54) BEVERAGE MAKING SYSTEM

(71) Applicant: LG Electronics Inc., Seoul (KR)

(72) Inventors: Jihyon YUN, Seoul (KR); Suyoung LEE, Seoul (KR); Seongju LIM, Seoul (KR); Joonsei LEE, Seoul (KR)

(21) Appl. No.: 18/202,547

(22) Filed: May 26, 2023

(30) Foreign Application Priority Data
May 27, 2022 (KR) 10-2022-0065035

(51) Int. Cl. C12C 11/00; C12C 13/10

(52) U.S. Cl. CPC C12C 11/006; C12C 13/10

(57) ABSTRACT

Provided is a beverage making system that includes a mobile terminal, a mobile terminal, a beverage maker configured to (i) communicate with at least one of the mobile terminal or a server, (ii) receive an upgrade item from the mobile terminal or the server, and (iii) make a beverage in a mode of a plurality of modes, a user interface disposed at at least one of the mobile terminal or the beverage maker, configured to (i) display beverage making information, and (ii) receive a user's command, and a controller configured to control the beverage maker according to an input from the user interface, wherein the plurality of modes comprises a normal mode configured to make the beverage using a predetermined ingredient, and store the made beverage in the beverage maker, and an upgrade mode configured to update the beverage making system by the mobile terminal or the server.

### CROSS-REFERENCE TO RELATED APPLICATIONS

The present application claims priority under 35 U.S.C. 119 and 35 U.S.C. 365 to Korean Patent Application No. 10-2022-0065035, filed on May 27, 2022, which is hereby incorporated by reference in its entirety.

### BACKGROUND

Beverages are collectively referred to as drinkable liquids such as alcohol or tea. For example, beverages can be divided into various categories such as a beverage to solve thirst (e.g., water), juice beverages with unique flavor and taste, refreshing beverages giving refreshing sensation, favorite beverages with an arousal effect, or alcoholic beverages with an alcohol effect.

Representative examples of such a beverage is beer. Beer is an alcoholic beverage made by producing wort of malt from sprouted barley, filtering the wort, adding hop, and fermenting the wort by using yeast.

Consumers can purchase ready-made products made and sold by a beer maker or home beer (or handmade beer) made by directly fermenting beer ingredients at home or in a bar.

In some examples, a beverage maker can be capable of safely and easily making house beer in a home or a bar.

In some examples, the beer maker can sequentially perform primary fermentation and secondary fermentation, and then perform aging. When the aging is completed, beer can be dispensed to the outside through a beer dispenser.

### SUMMARY

According to one aspect of the subject matter described in this application, a beverage making system can include a mobile terminal, a beverage maker configured to (i) communicate with at least one of the mobile terminal or a server, (ii) receive an upgrade item from the mobile terminal or the server, and (iii) make a beverage in a mode of a plurality of modes, a user interface disposed at at least one of the mobile terminal or the beverage maker, configured to (i) display beverage making information, and (ii) receive a user's command, and a controller configured to control the beverage maker according to an input from the user interface, wherein the plurality of modes comprises a normal mode configured to make the beverage using a predetermined ingredient, and store the made beverage in the beverage maker, and an upgrade mode configured to update the beverage making system by the mobile terminal or the server.

Implementations according to this aspect can include one or more of the following features. For example, based on the beverage making system being in the upgrade mode, at least one of a fermentation temperature, a fermentation time, or a fermentation pressure is different from when the beverage making system is in the normal mode. In some implementations, the upgrade mode includes a mix and match mode configured to make the beverage using an ingredient selected by a user, and store the made beverage in the beverage maker.

In some implementations, the beverage maker can be configured to, based on the beverage making system being in the mix and match mode, make a plurality of beverages, wherein making periods and fermentation temperatures of the plurality of beverages are different from each other. In some implementations, the user interface can be configured to display a first beverage name in the normal mode and a second beverage name in the mix and match mode.

In some implementations, the plurality of modes can further include an expert mode configure to (i) ferment the predetermined ingredient, (ii) extract the fermented ingredient from the beverage maker, and (iii) store the fermented ingredient in a separate container. In some implementations, the user interface can be configured to, based on the beverage making system being in the expert mode, display an expert mode card comprising a set state of the expert mode. In some implementations, the set state of the expert mode can comprise (i) addition of flavor and (ii) extraction of the made beverage after primary fermentation. In some implementations, a beverage making time in the expert mode can be less than a beverage making time in the normal mode.

In some implementations, the user interface can be configured to display product and function information.

In some implementations, the beverage maker can comprise a fermentation module configured to ferment the beverage, a temperature controller configured to control an inner temperature of the fermentation module, a water supply module configured to supply water to the beverage maker, an ingredient supplier configured to accommodate one or more ingredients for making the beverage, and a beverage dispenser configured to dispense the made beverage from the fermentation module to an outside of the beverage maker.

In some implementations, the fermentation module can comprise a fermentation tank module having an opening, and a fermentation lid configured to open and close the opening of the fermentation tank. In some implementations, the fermentation tank can include a fermentation container that is disposed in the fermentation tank.

In some implementations, the temperature controller can include a refrigerant cycle device configured to control the temperature of the fermentation tank, and a heater configured to provide heat to the fermentation tank.

In some implementations, the ingredient supplier can be configured to supply the one or more ingredients to a fermentation container with the water supplied from the water supply module. In some implementations, the ingredient supplier can include an ingredient accommodation portion, wherein the one or more ingredients are each accommodated in a capsule, and wherein each capsule is accommodated in the ingredient accommodation portion.

In some implementations, the beverage making system can further comprise a first main channel configured to couple the water supply module to the ingredient supplier, a second main channel configured to couple the ingredient supplier to the fermentation module and a bypass channel, wherein one end of the bypass channel is coupled to the first main channel and the other end of the bypass channel is coupled to the second main channel.

In some implementations, the beverage dispenser can include a dispenser configured to dispense the beverage and a beverage dispensing channel configured to couple the dispenser to the second main channel. In some implementations, the beverage dispenser can further comprise a tab configured to open and close the dispenser and disposed at the dispenser. In some implementations, the beverage dispensing channel can comprise a beverage dispending valve configured to open and close the beverage dispensing channel.

The details of one or more implementations are set forth in the accompanying drawings and the description below. Other features will be apparent from the description and drawings, and from the claims.

### BRIEF DESCRIPTION OF THE DRAWINGS

FIG. 1 is a view illustrating an example configuration of a beverage maker.

FIG. 2 is a flowchart illustrating a control sequence of one example of a normal mode.

FIG. 3 is a view illustrating an example state of a fermentation container and a capsule.

FIG. 4 is a view illustrating an example operating state of a beverage making system.

FIG. 5 is a schematic view illustrating an example of a making process in the normal mode and a making process in an expert mode.

FIG. 6 is a view illustrating an example of a user interface.

FIG. 7 is a view illustrating an example state of when the user interface taps a product.

FIG. 8 is a view illustrating an example of the user interface when the beverage maker makes a beverage in the normal mode.

FIG. 9 is a view illustrating an example of the user interface when the beverage maker makes a beverage in the expert mode.

FIGS. 10 to 17 are views illustrating examples of various displays due to a state in which the beverage is made.

FIG. 18 is a view illustrating an example of the user interface when the beverage maker stores a beverage.

FIGS. 19 to 22 are views illustrating an example of a process of entering the expert mode through the user interface.

FIGS. 23 to 26 are views illustrating an example of a process of inputting extraction after primary fermentation in the expert mode through the user interface.

FIG. 27 is a view illustrating an example state of when the user interface displays a notification card in the expert mode.

FIG. 28 is a view illustrating an example of a tab when a useful function of the user interface is tapped.

FIG. 29 is a view illustrating an example state of when the user interface displays a brewing record.

FIG. 30 is a view illustrating an example state of when the user interface displays brewing record details.

FIGS. 31 to 35 are views illustrating an example state of when the user interface edits the brewing record in the expert mode.

FIGS. 36 to 40 are views illustrating an example state of when the user interface edits the brewing record in a mix and match mode.

FIG. 41 is a view illustrating an example state of when the user interface displays setting.

FIG. 42 is a view illustrating an example state of when a recipe update is inputted.

FIG. 43 is a view illustrating an example state of when the recipe update is in progress.

FIG. 44 is a view illustrating an example state of when detailed product setting is inputted.

FIG. 45 is a view illustrating an example state of when the user interface displays that there is an upgrade item.

FIG. 46 is a view illustrating an example in which the user interface is connected to an UP home appliance center.

FIG. 47 is a view illustrating an example state of when the user interface displays the brewing record.

FIG. 48 is a view illustrating an example of the user interface when a brewing diary illustrated in FIG. 47 is inputted.

FIG. 49 is a view illustrating an example of capsule curation.

FIGS. 50 to 52 are views illustrating an example of a flow of the brewing record.

FIGS. 53 to 56 are views illustrating another example of the flow of the brewing record.

FIG. 56 is a view illustrating an example of a beverage making system.

### DETAILED DESCRIPTION

Hereinafter, detailed implementations will be described in detail with reference to the accompanying drawings.

Although beer is exemplified as a beverage made by using a beverage maker in this specification, a kind of beverages is not limited to the beer that is capable of being made by using the beverage maker. For example, various kinds of beverages can be made through the beverage maker according to implementations.

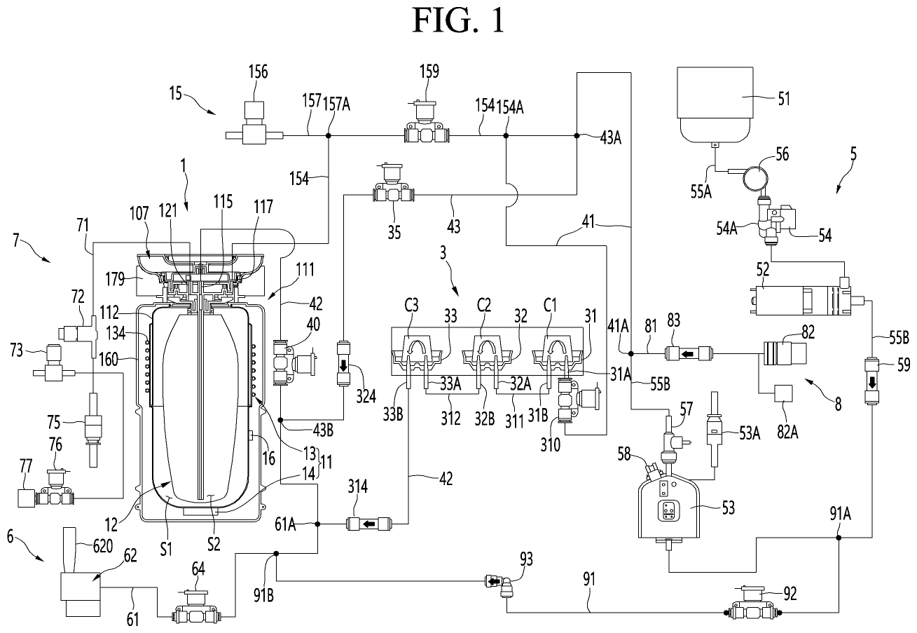

FIG. 1 is a view illustrating a configuration of a beverage maker.

In some implementations, a beverage maker can include a fermentation module 1. A beverage can be fermented in the fermentation module 1.

The beverage maker can include a temperature controller that controls an inner temperature of the fermentation module 1.

The beverage maker can include a water supply module 5. The water supply module 5 can supply water.

The beverage maker can include ingredient supplier 3 provided with ingredient accommodation portions 31, 32, and 33 in which ingredients required for making the beverage are accommodated.

The beverage maker can include main channels 41 and 42 connecting the water supply module 5 to the fermentation module 1.

The beverage maker can include a beverage dispenser 6 for dispensing the beverage made in the fermentation module 1 to the outside.

The beverage dispenser 6 can be connected to a second main channel 42. Thus, the beverage dispensed from the fermentation module 1 can be guided to the beverage dispenser 6 by passing through a portion of the second main channel 42.

The beverage maker can further include a gas discharger 7. The gas discharger 7 can be connected to the fermentation module 1 to discharge a gas generated while the beverage is made.

The beverage maker can further include an air injector for injecting air. The air injector 8 can be connected to the water supply module 5 or a first main channel 41. The air injector can include an air pump 82.

The beverage maker can further include an air controller 15 controlling a pressure between an inner wall of a fermentation tank 112 and an outer surface of a fermentation container 12.

The beverage maker can further include a sub channel 91. The sub channel 91 can connect the water supply module 5 to the beverage dispenser 6.

Hereinafter, the fermentation module 1 will be described in detail.

The fermentation module 1 can include a fermentation tank module 111 having an opening 170 and fermentation lid 107 that opens and closes the opening 170.

The fermentation tank module 111 can include a fermentation case 160 and a fermentation tank 112 accommodated in the fermentation case 160 and having an inner space S1. The insulating material can be provided between the fermentation case 160 and the fermentation tank 112. The fermentation tank module 111 can further include a lid seating body 179 on which the fermentation lid 107 is seated.

Each of the fermentation case 160 and the fermentation tank 112 can be provided as an assembly of a plurality of members. The fermentation case 160 can define an outer appearance of the fermentation tank module 111.

The fermentation lid 107 can seal the inside of the fermentation tank module 111 and be disposed on the fermentation tank module 111 to cover the opening. A main channel, particularly, a main channel connection portion 115 connected to a second main channel 42 can be provided in the fermentation lid 107.

A fermentation container 12 can be accommodated in the fermentation tank 112.

The fermentation container 12 can be provided as a separate container so that the beverage ingredients and the made beverage stain an inner wall of the fermentation tank 112. The fermentation container 12 can be separably disposed on the fermentation tank 112. The fermentation container 12 can be seated on the fermentation tank 112 to ferment the beverage within the fermentation tank 112. After the fermentation container 12 is used, the fermentation container 12 can be withdrawn to the outside of the fermentation tank 112.

The fermentation container 12 can be a pack containing the ingredients for making the beverage. The fermentation container 12 can be made of a flexible material. Thus, the fermentation container 12 can be easily inserted into the fermentation tank 112 and be contracted and expanded by a pressure. However, the implementations may not be limited thereto. For example, the fermentation container 12 can be made of polyethylene terephthalate (PET) material.

The fermentation container 12 can have a beverage making space S2 in which the beverage ingredients are accommodated, and the beverage is made. The fermentation container 12 can have a size less than that of the inner space S1 of the fermentation tank 112.

The fermentation container 12 can be inserted and accommodated into the fermentation tank 112 in the state in which the ingredients are contained in the fermentation container 12. The fermentation container 12 can be inserted into the fermentation tank 112 and then accommodated in the fermentation tank 112 in the state in which the fermentation lid 107 is opened.

The fermentation lid 107 can seal the fermentation tank 112 after the fermentation container 12 is inserted into the fermentation tank 112. The fermentation container 12 can assist the fermentation of the ingredient in the state in which the fermentation container 12 is accommodated in the space S1 that is sealed by the fermentation tank 112 and the fermentation lid 107. The fermentation container 12 can be expanded by the pressure therein during the making of the beverage. The fermentation container 12 can be pressed by the air within the fermentation tank 112 when the beverage contained in the fermentation container 12 is dispensed, and the air is supplied between an inner surface of the fermentation tank 112 and the fermentation container 12.

The fermentation tank 112 can be disposed in the fermentation case 160. The fermentation tank 112 can have an outer circumference surface and a bottom surface, which are spaced apart from the inner surface of the fermentation case 160. In more detail, the outer circumference the fermentation tank 112 can be spaced apart from an inner circumference of the fermentation case 160, and an outer bottom surface of the fermentation tank 112 can be spaced apart from an inner bottom surface of the fermentation case 160.

The insulating material can be provided between the fermentation case 160 and the fermentation tank 112. The insulating material can be disposed in the fermentation case 160 to surround the fermentation tank 112. Thus, the fermentation tank 112 can be constantly maintained in temperature.

The insulating material can be made of a material such as foamed polystyrene or polyurethane which has high thermal insulating performance and absorbs vibration.

The fermentation tank 112 can include a temperature sensor 16 for measuring the temperature of the inner fermentation tank 112.

The temperature sensor 16 can be mounted on a circumferential surface of the fermentation tank 112. The temperature sensor 16 can be disposed below an evaporator 134 wound around the fermentation tank 112.

Hereinafter, the temperature controller 11 will be described in detail.

The temperature controller 11 can change an inner temperature of the fermentation module 101. In more detail, the temperature controller 11 can change a temperature of the fermentation tank 112.

The temperature controller 11 can heat or cool the fermentation tank 112 to control a temperature of the fermentation tank 112 at an optimal temperature for fermenting the beverage.

The temperature controller 11 can include at least one of a refrigerant cycle device 13 and a heater 14. However, the implementations may not be limited thereto. For example, the temperature controller 11 can include a thermoelement TEM.

The refrigerant cycle device 13 can control the fermentation tank 112 to adjust a temperature of the fermentation tank 112. The refrigerant cycle device 13 can include a compressor, a condenser, an expansion mechanism, and an evaporator 134.

The evaporator 134 can be disposed to contact an outer surface of the fermentation tank 112. The evaporator 134 can be provided as an evaporation tube wound around an outer surface of the fermentation tank 112. The evaporator 134 can be accommodated between the fermentation tank 112 and the insulating material to cool the fermentation tank 112 that is insulated by the insulating material.

The temperature controller 11 can further include a heater 14 heating the fermentation tank 112. The heater 14 can be installed to contact the bottom surface of the fermentation tank 112. The heater 14 can be provided as a heat generation heater that generates heat when power is applied. The heater 14 can be provided as a plate heater.

Thus, the natural convection of a fluid can be generated inside the fermentation tank 112 by the evaporator 134 and the heater 14, and temperature distribution inside the fermentation tank 112 and the fermentation container 12 can be uniform.

Hereinafter, the main channels 41 and 42 and a bypass channel 43 will be described.

As described above, the main channels 41 and 42 can include a first main channel 41 connecting the water supply module 5 to the ingredient supplier 3 and a second main channel 42 connecting the ingredient supplier 3 to the fermentation module 1.

That is, the first main channel 41 can guide water supplied from the water supply module 5 to the ingredient supplier 3, and the second main channel 42 can guide the mixture of the ingredients and the water, which are extracted from the ingredient supplier 3, to the fermentation module 1.

The first main channel 41 can have one end 41A connected to the water supply module 5 and the other end connected to the ingredient supplier 3, more particularly, an inlet of an initial ingredient accommodation portion 31, which will be described below in more detail.

An ingredient supply valve 310 opening and closing the first main channel 41 can be installed in the first main channel 41. The ingredient supply valve 310 can be provided in the ingredient supplier 3.

The ingredient supply valve 310 can be opened when additives accommodated in the ingredient accommodation portions 31, 32, and 33 are put to open the first main channel 41. The ingredient supply valve 310 can be opened when the ingredient accommodation portions 31, 32, and 33 are cleaned to open the first main channel 41.

The second main channel 42 can have one end connected to a main channel connecting portion 115 of the fermentation module 1 and the other end connected to the ingredient supplier 3, more particularly, an outlet 33B of a final ingredient accommodation portion 33, which will be described below in more detail.

A main valve 40 opening and closing the second main channel 42 can be installed in the second main channel 42. Also, a main check valve 314 for allowing the fluid to flow from the ingredient supplier 3 to the fermentation module 1 can be installed in the second main channel 42. That is, the main check valve 314 can prevent the fluid from flowing back to the ingredient supplier 3.

The main check valve 314 can be disposed between the main valve 40 and the ingredient supplier 3 with respect to the second main channel 42.

The main valve 40 can be opened when the water is supplied to the fermentation container 12 to open the second main channel 42. The main valve 40 can be closed while the fermentation tank 112 is cooled to close the second main channel 42. The main valve 40 can be opened when the air is injected into the fermentation container 12 to open the second main channel 42. The main valve 40 can be opened when the additives are supplied into the fermentation container 12 to open the second main channel 42. The main valve 40 can be closed to seal the inside of the fermentation container 12 during the fermentation of the ingredients. The main valve 40 can be closed to seal the inside of the fermentation container 12 when the beverage is aged and stored. The main valve 40 can be opened when the beverage is dispensed by the beverage dispenser 6 to open the second main channel 4. The beverage within the fermentation container 12 can pass through the main valve 40 to flow to the beverage dispenser 6.

The main channels 41 and 42 can be provided as one continuous channel when the beverage maker does not include the ingredient supplier 3.

When the beverage maker includes the ingredient supplier 3, the beverage maker can further include a bypass channel 43 configured to allow the water or the air to bypass the ingredient accommodation portions 31 and 32.

The bypass channel 43 can bypass the ingredient accommodation portions 31, 32, and 33 and then be connected to the first main channel 41 and the second main channel 42.

The bypass channel 43 can have one end connected to the first main channel 41 and the other end connected to the second main channel 42. In more detail, the bypass channel 43 can have one end 43A connected to the first main channel 41 between the water supply module 5 and the ingredient supply valve 310 and the other end 43B connected to the second main channel 42 between the main valve 40 and the ingredient supplier 3.

A bypass valve 35 opening and closing the bypass channel 43 can be installed in the bypass channel 43.

The bypass valve 35 can be opened when the water supplied from the water supply module 5 is supplied to the fermentation container 12 to open the bypass channel 43. The bypass valve 35 can be opened when the air injected from the air injector 8 is supplied to the fermentation container 12 to open the bypass channel 43. The bypass valve 35 can be opened when the bypass channel 43 is cleaned to open the bypass channel 43.

Also, a bypass check valve 324 allowing the fluid to flow from the first main channel 41 to the second main channel 42 can be installed in the bypass channel 43. That is, the fluid can flow only from the first main channel 41 to the second main channel 42 but may not flow in the opposite direction.

The bypass check valve 324 can be disposed between the bypass valve 35 and the second main channel 42 with respect to the bypass channel 43.

Hereinafter, the ingredient supplier 3 will be described in detail.

When beer is made by using the beverage maker, the ingredients for making the beer can include water, malt, yeast, hop, Flavoring additives, and the like.

The beverage maker can include all of the ingredient supplier 3 and the fermentation container 12. The ingredients for making the beverage can be accommodated to be divided into the ingredient supplier and fermentation container 12. A portion of the ingredients for making the beverage can be accommodated in the fermentation container 12, and the remaining ingredients can be accommodated in the ingredient supplier 3. The remaining ingredients accommodated in the ingredient supplier 3 can be supplied to the fermentation container 12 together with the water supplied from the water supply module 5 and mixed with the portion of the ingredients accommodated in the fermentation container 12.

A main ingredient that is essential for making the beverage can be accommodated in the fermentation container 12, and the additives added to the main ingredient can be accommodated in the ingredient supplier 3. In this case, the additives accommodated in the ingredient supplier 3 can be mixed with the water supplied from the water supply module 5 and supplied to the fermentation container 12 and then be mixed with the main ingredient accommodated in the fermentation container 12.

The main ingredient accommodated in the fermentation container 12 can have a capacity greater than that of other ingredients. For example, when the beer is made, the main material can be the malt of the malt, the yeast, the hop, and the Flavoring additives. Also, the additive accommodated in the ingredient supplier 3 can be the other ingredient except for the malt of the ingredient for making the beer, for example, the yeast, the hop, and the Flavoring additives.

The beverage maker may not include the ingredient supplier 3 but include the fermentation container 12. In this case, the main ingredient can be accommodated in the fermentation container 12, and the user can directly put the additives into the fermentation container 12.

If the beverage maker includes all the ingredient supplier 3 and the fermentation container 12, the beverage can be more easily made. Hereinafter, the case in which the beverage maker includes all of the ingredient supplier 3 and the fermentation container, will be described as an example. However, the implementations may not be limited to the case in which the beverage maker includes all of the ingredient supplier 3 and the fermentation container 12.

The ingredients within the fermentation container 12 can be fermented as time elapses, and the beverage made in the fermentation container 12 can flow to the second main channel 42 through the main channel connection portion 115 and also flow from the second main channel 42 to the beverage dispenser 6 so as to be dispensed.

The ingredients that are necessary for making the beverage can be accommodated in the ingredient supplier 3, and the water supplied from the water supply module 5 can pass through ingredient supplier 3. For example, when the beverage made in the beverage maker is beer, the ingredient accommodated in the ingredient supplier 3 can be yeast, hop, flavoring additives, and the like.

The ingredient accommodated in the ingredient supplier 3 can be directly accommodated into an ingredient accommodation portions 31, 32, and 33 provided in the ingredient supplier 3. At least one ingredient accommodation portion 31, 32, and 33 can be provided in the ingredient supplier 3. The plurality of ingredient accommodation portions 31, 32, and 33 can be provided in the ingredient supplier. In this case, the ingredient accommodation portions 31, 32, and 33 can be partitioned with respect to each other.

Inlets 31A, 32A, and 33A through which the fluid is introduced and outlets 31B, 32B, and 33B through which the fluid is discharged can be provided in the ingredient accommodation portions 31, 32, and 33, respectively. The fluid introduced into the inlet of one ingredient accommodation portion can be mixed with the ingredients within the ingredient accommodation portions and then discharged through the outlet.

The ingredients accommodated in the ingredient supplier 3 can be accommodated in capsules C1, C2, and C3. In this case, the capsules C1, C2, and C3 can be accommodated in the ingredient accommodating parts 31, 32, and 33, and each of the ingredient accommodating parts 31, 32, and 33 can be called a capsule mounting portion.

When the ingredients are accommodated in the capsules C1, C2, and C3, the ingredient supplier 3 can be configured so that the capsules C1, C2, and C3 are seated and withdrawn. The ingredient supplier can be provided as a capsule kit assembly in which the capsules C1, C2, and C3 are separably accommodated.

For example, a first additive, a second additive, and a third additive can be accommodated in the ingredient supplier 3. The first additive can be yeast, the second additive can be hop, and the third additive can be a flavoring additive. The ingredient supplier 3 can include a first capsule mounting portion 31 in which a first capsule C1 containing the first additive is accommodated, a second capsule mounting portion 32 in which a second capsule C2 containing the second additive is accommodated, and a third capsule mounting portion 33 in which a third capsule C3 containing the third additive is accommodated.

The ingredients contained in the ingredient accommodation portion or the capsules C1, C2, and C3 can be extracted by a water pressure of the water supplied from the water supply module 5.

When the ingredients are extracted by the water pressure, the water supplied from the water supply module 5 to the first main channel 41 can pass through the ingredient accommodation portion or the capsules C1, C2, and C3 and then be mixed with the ingredients, and the ingredients accommodated in the ingredient accommodation portion or the capsules C1, C2, and C3 can flow to the second main channel together with the water.

A plurality of additives different from each other can be accommodated to be divided in the ingredient supplier 3. For example, when the beer is made, the plurality of additives accommodated in the ingredient supplier 3 can be the yeast, the hop, and the flavoring additive, which are accommodated to be divided from each other.

When the plurality of ingredient accommodation portions are provided in the ingredient supplier 3, the plurality of ingredient accommodation portions 31, 32, and 33 can be connected in series to each other in a flow direction of the water.

In more detail, the ingredient supplier 3 can include at least one connecting channel 311 and 312 connecting the outlet of one ingredient accommodation portion of the plurality of ingredient accommodation portions 31, 32, and 33 to the inlet of the other ingredient accommodation portion.

Also, the plurality of ingredient accommodation portions 31, 32, and 33 can include an initial ingredient accommodation portion 31 and a final ingredient accommodation portion 33. The plurality of ingredient accommodation portions 31, 32, and 333 can further include an intermediate ingredient accommodation portion 32.

The inlet 31A of the initial ingredient accommodation portion 31 can be connected to the first main channel 41, and the outlet 33B of the final ingredient accommodation portion 33 can be connected to the second main channel 42.

The intermediate ingredient accommodation portion 32 can be disposed between the first ingredient accommodation portion 31 and the second ingredient accommodation portion 33 in the flow direction of the fluid. The inlet 32A and the outlet 32B of the intermediate ingredient accommodation portion 32 can be connected to the connecting channels 311 and 312 different from each other.

As illustrated in FIG. 1, when three ingredient accommodation portions are provided in the ingredient supplier 3, the outlet 31B of the final ingredient accommodation portion 31 can be connected to the inlet 32A of the intermediate ingredient accommodation portion 32 through the first connecting channel 311, and the outlet 32B of the intermediate ingredient accommodation portion 32 can be connected to the inlet 33A of the final ingredient accommodation portion 33 through the second connecting channel 312.

In this case, the water introduced into the inlet 31A of the final ingredient accommodation portion 31 through the first main channel 41 can flow to the first connecting channel 311 through the outlet 31B together with the first additive accommodated in the initial ingredient accommodation portion 31.

The fluid (the mixture of the water and the first additive) introduced into the inlet 32A of the intermediate ingredient accommodation portion 32 through the first main channel 311 can flow to the second connecting channel 312 through the outlet 32B together with the second additive accommodated in the intermediate ingredient accommodation portion 32.

The fluid (the mixture of the water and the first and second additives) introduced into the inlet 33A of the final ingredient accommodation portion 33 through the second main channel 312 can flow to the second connecting channel 42 through the outlet 33B together with the third additive accommodated in the final ingredient accommodation portion 33.

The fluid (the mixture of the water and the first, second, and third additives) discharged through the second main channel 42 can be guided to the main channel connection portion 115 of the fermentation module 1 and then introduced into the fermentation container 12.

However, the configuration of the ingredient supplier is not limited thereto. For example, when the intermediate ingredient accommodation portion is not provided, two ingredient accommodation portions can be provided in the ingredient supplier 3. In this case, one ingredient accommodation portion can be the initial ingredient accommodation portion, and the other ingredient accommodation portion can be the final ingredient accommodation portion. The outlet of the initial ingredient accommodation portion and the inlet of the final ingredient accommodation portion can be connected to each other by the connecting channel.

For another example, when the intermediate ingredient accommodation portion is provided in plurality, four or more ingredient accommodation portions can be provided in the ingredient supplier 3. In this case, one ingredient accommodation portion can be the initial ingredient accommodation portion, the other ingredient accommodation portion can be the final ingredient accommodation portion, and the remaining ingredient accommodation portion can be the intermediate ingredient accommodation portion. In this case, since the connection between the ingredient accommodation portions in series is easily understood by the person skilled in the art, their detailed descriptions will be omitted.

Since the plurality of ingredient accommodation portions 31, 32, and 33 are connected in series to each other, the channel configuration of the ingredient supplier 3 can be simplified. Also, since the additives contained in the capsules C1, C2, and C3 are extracted at once, a time taken to extract the additives can decrease. Also, since the user does not have to worry about the mounting order of the capsules C1, C2, and C3, malfunction due to the mounting of the capsules C1, C2, and C3 in erroneous order may not occur. Also, the ingredient supplier 3 can be minimized in water leakage point to improve reliability.

When the ingredients accommodated in the ingredient supplier 3 are accommodated in the capsules C1, C2, and C3, the initial ingredient accommodation portion 31 can be called an initial capsule mounting portion, the intermediate ingredient accommodation portion 32 can be called an intermediate capsule mounting portion, and the final ingredient accommodation portion 33 can be a final capsule mounting portion.

Hereinafter, the water supply module 5 will be described in detail.

The water supply module 5 can include a water tank 51, a water supply pump 52 for pumping water within the water tank 51, and a water supply heater 53 for heating the water pumped by the water supply pump 52.

The water supply module 5 can further include the water supply pump 52 for pumping water within the water tank 51 and the water supply heater 53 for heating the water pumped by the water supply pump 52.

The water tank 51 and the water supply pump 52 can be connected to a water tank discharge channel 55A, and the water contained in the water tank 51 can be introduced into the water supply pump 52 through the water tank discharge channel 55A.

The water supply pump 52 and one end of the first main channel 41 can be connected to a water supply channel 55B, and the water discharged from the water supply pump can be guided to the first main channel 41 through the water supply channel 55B.

A flow meter 56 for measuring a flow rate of the water discharged from the water tank 51 can be installed in the water tank discharge channel 55A.

Also, a flow rate control valve 54 for controlling the flow rate of the water discharged from the water tank 51 can be installed in the water tank discharge channel 55A. The flow rate control valve 54 can include a step-in motor.

Also, a thermistor 54A for measuring a temperature of the water discharged from the water tank 51 can be installed in the water tank discharge channel 55A. The thermistor 54A can be built in the flow rate control valve 54.

A water supply check valve 59 for preventing the water from flow back to the water supply pump 52 can be installed in the water supply channel 55B.

The water supply heater 53 can be installed in the water supply channel 55B.

The water supply heater 53 can be a mold heater and include a heater case through which the water pumped by the water supply pump 52 passes and a heat generation heater installed in the heater case to heat the water introduced into the heater case.

A thermal fuse 58 for interrupting a circuit to cutoff current applied to the water supply heater 53 when a temperature is high can be installed in the water supply heater 53.

The water supply module 5 can further include a safety valve 53A. The safety valve 53A can communicate with the inside of the heater case of the water supply heater 53. The safety valve 53A can restrict a maximum inner pressure of the heater case. For example, the safety valve 53A can restrict the maximum inner pressure of the heater case to a pressure of about 3.0 bar.

The water supply module 5 can further include a water supply temperature sensor 57 for measuring a temperature of the water passing through the water supply heater 53. The water supply temperature sensor 57 can be installed in the water supply heater 53. Alternatively, the water supply temperature sensor 57 can be disposed at a portion of the water supply channel behind the water supply heater 53 in the flow direction of the water. Also, the water supply temperature sensor 57 can be installed in the first main channel 41.

When the water supply pump 52 is driven, the water within the water tank 51 can be introduced into the water supply pump 52 through the water tank discharge channel 55A, and the water discharged from the water supply pump 52 can be heated in the water supply heater 53 while flowing through the water supply channel 55B and then be guided to the first main channel 41.

Hereinafter, the beverage dispenser 6 will be described.

The beverage dispenser 6 can be connected to the second main channel 42.

In more detail, the beverage dispenser 6 can include a dispenser 62 for dispensing the beverage and a beverage dispensing channel 61 connecting to the dispenser 62 to the second main channel 42.

A tab 620 manipulated by a user to open/close the dispenser 62 can be mounted on the dispenser 62. When the dispenser 62 pulls the tab 620 forward, the beverage can be extracted to the outside, and when the tab 620 stands back, the beverage can be blocked.

The beverage dispensing channel 61 can have one end 61A connected between the main check valve 314 and the main valve 40 with respect to the second main channel 42 and the other end connected to the dispenser 62.

A beverage dispensing valve 64 opening and closing the beverage dispensing channel 61 can be installed in the beverage dispensing channel 61.

The beverage dispensing valve 64 can be opened when the beverage is dispensed to open the beverage dispensing channel 61. The beverage dispensing valve 64 can be opened when residual water is removed to open the beverage dispensing channel 61. The beverage dispensing valve 64 can be opened when the beverage dispenser is cleaned to open the beverage dispensing channel 61.

An anti-foaming portion can be provided in the beverage dispensing channel 61, and an amount of foam of the beverage flowing from the second main passage 42 to the beverage dispensing channel 61 can be minimized while passing through the anti-foaming part. A mesh for filtering the foam can be provided in the anti-foaming portion 63.

When the beverage is dispensed, the beverage dispensing valve 64 can be opened. When the beverage is not dispensed, the closed state of the beverage dispensing valve 64 can be maintained.

Hereinafter, the gas discharger 7 will be described in detail.

The gas discharger 7 can be connected to the fermentation module 1 to discharge a gas generated in the fermentation container 12.

In more detail, the gas discharger 7 can include a gas discharge channel 71 connected to the fermentation module, a gas pressure sensor 72 installed in the gas discharge channel 71, and a gas discharge valve 73 connected behind the gas pressure sensor 72 in the gas discharge channel 71 in the gas discharge direction.

The gas discharge channel 71 can be connected to the fermentation module 1, particularly, the fermentation lid 107. A gas discharge channel connection portion 121 to which the gas discharge channel 71 is connected can be provided in the fermentation lid 107.

The gas within the fermentation container 12 can flow into the gas discharge channel 71 and the gas pressure sensor 72 through the gas discharge channel connecting portion 121. The gas pressure sensor 72 can detect a pressure of the gas discharged to the gas discharge channel 71 through the gas discharge channel connection portion 121 within the fermentation container 12.

The gas discharge valve 73 can be turned to be opened when the air is injected into the fermentation container 12 by the air injector 8. The beverage maker can uniformly mix the malt with the water by injecting the air into the fermentation container 12. Here, foam generated in the liquid malt can be discharged from the upper portion of the fermentation container 12 to the outside through the gas discharge channel 71 and the gas discharge valve 73.

The gas discharge valve 73 can be turned on to detect fermentation during the fermentation process and then turned off to be closed.

The gas discharger 7 can further include the safety valve 75 connected to the gas discharge channel 71. The safety valve 75 can be connected behind the gas pressure sensor 71 in the gas discharge channel 71 in the gas discharge direction. The safety valve 75 can restrict a maximum pressure of the fermentation container 12 and the gas discharge channel 71. For example, the safety valve 75 can restrict the maximum pressure of the fermentation container 12 and the gas discharge channel 71 to a pressure of about 3.0 bar.

The gas discharger 7 can further include a pressure release valve 76.

The pressure release valve 76 can be connected to the gas discharge channel 71. The pressure release valve 76 and the gas discharge valve 73 can be selectively opened/closed.

The gas discharge channel 71 can be branched to be respectively connected to the gas discharge valve 73 and the pressure release valve 76.

A noise reducing device 77 can be mounted on the pressure release valve 76. The noise reducing device 77 can include at least one of an orifice and a muffler.

Even though the pressure release valve 76 is opened, an inner pressure of the fermentation container 12 can gradually decrease by the noise reducing device 77.

When the fermentation of the beverage progresses, the pressure release valve 76 can be opened to release the pressure in the state in which the inner pressure of the fermentation container 12 increases. The noise reducing device 77 can effectively reduce noise generated due to a difference in pressure of the inside and outside of the fermentation container 12.

The pressure release valve 76 can be controlled to be opened/closed in a secondary fermentation process (S800) that will be described below.

Hereinafter, the air injector 8 will be described.

The air injector 8 can be connected to the water supply module 55B or the first main channel 41 to inject air. Hereinafter, for convenience of description, the case in which the air injector 8 is connected to the water supply channel 55B will be described as an example.

The air injector 8 can be connected to an opposite side of a sub channel 91, which will be described later, with respect to the water supply heater 53.

In this case, the air injected into the air injector 8 can pass through the water supply heater 53 to flow to the sub channel 91 together with the residual water within the water supply heater 53. Thus, the residual water within the water supply heater 53 can be removed to maintain a clean state of the water supply heater 53.

Alternatively, the air injected from the air injector 8 to the first main channel 41 can successively pass through the bypass channel 43 and the second main channel 42 and then be injected into the fermentation container 12. Thus, stirring or aeration can be performed in the fermentation container 12.

Alternatively, the air injected from the air injector 8 to the first main channel 41 can be guided to the ingredient supplier 3 to flow to the capsule mounting portions 31, 32, and 33. The residual water or residues within the capsules C1, C2, and C3 or the capsule mounting portions 31, 32, and 33 can flow to the second main channel 42 by the air injected by the air injector 8. The capsules C1, C2, and C3 and the capsule mounting portions 31, 32, and 33 can be cleanly maintained by the air injected by the air injector 8.

The air injector 8 can include an air injection channel connected to the water supply channel 55B or the first main channel 41 and an air pump 82 connected to the air injection channel 81. The air pump 82 can pump the air to the air injection channel 81.

An air injection check valve 83 preventing the water flowing to the water supply channel 55B by the water supply pump 52 from being introduced into the air pump 82 through the air injection channel 81 can be installed in the air injection channel 81.

The air injector 8 can further include an air filter 82A. The air filter 82A can be provided in a suction portion of the air pump 82, and thus, external air can be suctioned into the air pump 82 by passing through the air filter 82A. Thus, the air pump 82 can inject clean air into the air injection channel 81.

Hereinafter, the air controller 15 will be described in detail.

The air controller 15 can control a pressure between an inner wall of the fermentation tank 112 and an outer surface of the fermentation container 12.

The air controller 15 can supply air into a space between the fermentation container 12 and the fermentation tank 112. On the other hand, the air controller 15 can exhaust the air within the space between the fermentation container 12 and the fermentation tank 112 to the outside.

The air controller 15 can include an air supply channel 154 connected to the fermentation module 1 and an exhaust channel 157 connected to the air supply channel 154 to exhaust the air to the outside.

The air supply channel 154 can have one end connected to the first main channel 41 and the other end connected to the fermentation module 1.

The air supply channel 154 can be connected to the fermentation module 1, particularly, the fermentation lid 107. An air supply channel connecting portion 117 to which the air supply channel 154 is connected can be provided in the fermentation module 1. The air supply channel connecting portion 117 can communicate with the space between the inner wall of the fermentation tank 112 and the outer surface of the fermentation container 12.

The air injected from the air injector 8 to the first main channel 41 can be guided between the outer surface of the fermentation container 12 and the inner wall of the fermentation tank 112 through the air supply channel 154.

The air injector 8 can function as an air supplier for supplying the air into the space between the fermentation container 12 and the fermentation tank 112 together with the air supply channel 154.

As described above, the air supplied into the fermentation tank 112 can press the fermentation container 12 between the outer surface of the fermentation container 12 and the inner wall of the fermentation tank 112.

The beverage within the fermentation container 12 can be pressed by the fermentation container 12 that is pushed by the air. When the main valve 40 and the beverage dispensing valve 64 are opened, the beverage can pass through the main channel connecting portion 115 to flow to the second main channel 42. The beverage flowing from the fermentation container 12 to the second main channel 42 can be dispensed to the outside through the beverage dispenser 6.

The air pump 82 can supply air so that a predetermined pressure occurs between the fermentation container 12 and the fermentation tank 112. Thus, a pressure at which the beverage within the fermentation container 12 is easily dispensed can occur between the fermentation container 12 and the fermentation tank 112.

The air pump 82 can be maintained in the turn-off state while the beverage is dispensed. When the beverage is completely dispensed, the air pump 82 can be driven for next beverage dispensing and then stopped.

Thus, when the beverage is completely made, the beverage maker can dispense the beverage within the fermentation container 12 to the beverage dispensing channel module 6 in the state in which the fermentation container 12 is disposed within the fermentation module 1 without withdrawing the fermentation container 12 to the outside of the fermentation module 1.

The air controller 15 can include a separate air supply pump with respect to the air injector 8. In this case, the air supply channel 154 can be connected to the air supply pump, but may not connected to the first main channel 41. However, the injection of the air into the fermentation container 12 by the air pump 82 and the supplying of the air into the space between the fermentation container 12 and the fermentation tank 112 can be combined with each other to realize a compact product and reduce a manufacturing cost.

The exhaust channel 157 can function as an air exhaust passage, through which the air between the fermentation container 12 and the fermentation tank 112 is exhausted to the outside, together with a portion of the air supply channel 154.

The exhaust channel 157 can be disposed outside the fermentation module 1. The exhaust channel 157 can be connected to a portion of the air supply channel 154, which is disposed outside the fermentation tank 112.

The air supply channel 154 can include a first channel connected between a connecting portion 157A connected to the first main channel 41 and the exhaust channel 157 and a second channel connected between the connecting portion 154A connected to the exhaust channel 157 and the air supply channel connecting portion 117. The first channel can be an air supply channel for guiding the air pumped by the air pump 82 to the second channel. Also, the second channel can be an air supply and exhaust-combined channel for supplying the air passing through the air supply channel into the space between the fermentation tank 112 and the fermentation container 12 or guiding the air discharged from the space between the fermentation tank 112 and the fermentation container 12 t the connecting channel 157.

The exhaust channel 157 can be connected to the exhaust valve 156 for opening and closing the exhaust channel 157.

The exhaust valve 156 can be opened so that the air between the fermentation container 12 and the fermentation tank 112 is exhausted to the outside when the fermentation container 12 is expanded while the beverage is made. The exhaust valve 156 can be controlled to be opened when the water is supplied by the water supply module 5. The exhaust valve 156 can be controlled to be opened when the air is injected by the air injection channel module 8.

The exhaust valve 156 can be opened so that the air between the fermentation container 12 and the fermentation tank 112 is exhausted when the beverage within the fermentation container 12 is completely dispensed. The user can take the fermentation container out of the fermentation tank 112 when the beverage is completely dispensed. This is done because safety accidents occur when the inside of the fermentation tank 112 is maintained at a high pressure. The exhaust valve 156 can be controlled to be opened when the beverage within the fermentation container 12 is completely dispensed.

The air controller 15 can further include an air supply valve 159 that restricts the air pumped by the air pump 82 and supplied between the fermentation container 12 and the fermentation tank 112.

The air supply valve 159 can be installed in the air supply channel 154. In more detail, the air supply valve 159 can be installed between the connecting portion 154A of the first main channel 41 and the connecting portion 157A of the exhaust channel 157 in the air supply channel 154.

Hereinafter, the sub channel 91 will be described in detail.

The sub channel 91 can connect the water supply module 5 to the beverage dispenser 6. In more detail, the sub channel 91 can have one end 91A connected to the water supply channel 55B and the other end 91B connected to the beverage dispensing channel 61.

The sub channel 91 can be connected between the water supply pump 52 and the water supply heater 53 with respect to the water supply channel 55B.

Also, the sub channel 91 can be connected to the connection portion 61A of the second main channel 42 and the beverage dispensing valve 64 with respect to the beverage dispensing channel 61.

The water supplied by the water supply pump 52 and the air pumped by the air pump 82 can be guided to the beverage dispensing channel 61 through the sub channel 91 and then be dispensed to the dispenser 62. Thus, the residual water or the beverage remaining in the beverage dispenser 6 can be removed.

A sub valve 92 opening and closing the sub channel 91 can be installed in the sub channel 91.

The sub valve 92 can be opened when the beverage is dispensed, or the cleaning is performed to open the sub channel 91.

Also, a sub check valve 93 for preventing the beverage of the beverage dispensing channel 61 from flowing back to the water supply module 5 can be installed in the sub channel 91. The sub check valve 93 can be disposed between the sub valve 92 and the beverage dispensing channel 61 with respect to the sub channel 91.

The sub channel 91 can function as a residual water removing channel of the water supply module 5. For example, when the air pump 82 is turned on in the state in which the air supply valve 159, the bypass valve 35, and the ingredient supply valve 310 are closed, the sub valve 92 is opened, the air injected into the air injection channel 81 can pass through the water supply heater 53 to flow to the sub channel 91. Then, the air can pass through the sub valve 92 to flow to the beverage dispensing channel 61 and then be dispensed to the dispenser 62. In this process, the air can be dispensed together with the water supply module 5, more particularly, the residual water remaining the water supply heater 53 and the water supply channel 55B so that residual water is removed.

Also, the sub channel 91 can function as a cleaning channel. This will be described in detail in the cleaning process (S100) and the dispenser cleaning process in the beverage dispensing process (S1000), which will be described later.

The beverage maker can include a display for displaying various pieces of information of the beverage maker.

The display can include a display element such as an LCD, an LED, an OLED, and the like. The display can include a display PCB on which the display element is installed. The display PCB can be electrically connected to a controller to be described later.

The beverage maker can include an input unit receiving a command related to the making of the beverage maker. The input unit can be electrically connected to the controller that will be described later. The input unit can include at least one of a touch screen receiving a user's command in a touch member, a rotary knob held by the user to rotate, and a button pushed by the user.

For example, the input unit can include the rotary knob. The rotary knob can be disposed on a center cover 213.

The rotary knob can function as a button that is pushed by the user. That is, the user can hold the rotary knob so that the rotary knob rotates, or the user can input a control command by pushing a front surface of the rotary knob.

Also, the input unit can include the touch screen receiving a user's command in a touch manner. The touch screen can be provided on the display, and the display can function as the touch screen.

Also, the beverage maker can further include a wireless communication module. In some examples, the implementations may not be limited to kinds of wireless communication modules. For example, the wireless communication module can include a Bluetooth module and Wi-Fi module.

The wireless communication module can be electrically connected to the controller that will be described later. The beverage maker can wirelessly communicate with a separate mobile terminal and the like. The user can input a command, inquire making information, or monitor a making process in real time by using the mobile terminal.

The beverage maker includes a control module that substantially controls operations of components of the beverage maker, and the control module can include a controller.

The controller included in the control module can be electrically connected to the wireless communication module. For example, the controller can receive a command received through the wireless communication module, and thus, the beverage can be made. Also, the controller can transmit information related to the beverage maker or the beverage to be made from the wireless communication module to a separate mobile terminal.

Also, the controller can receive the command inputted into the input unit. For example, the controller can make a beverage according to the command inputted by the rotary knob. In addition, the controller can control to output various information of the beverage maker to the display. For example, the controller can display an amount of dispensed beverage, an amount of residual beverage, information related to completion of dispensing of the beverage, and the like through the display.

The controller can control at least one of the water supply pump 52, the water supply heater 53, the air pump 82, or the temperature controller 11. Also, controller can control at least one of the flow rate control valve 54, the ingredient supply valve 310, the main valve 40, the bypass valve 35, the air supply valve 159, the exhaust valve 156, the beverage dispensing valve 64, the sub valve 92, the gas discharge valve 73, or the pressure release valve 76.

The controller can receive a measured value of at least one of the flow meter 56, the thermistor 54A, the water supply temperature sensor 57, the temperature sensor 16, or the gas pressure sensor 72.

In more detail, the controller can detect an inner pressure of the fermentation container 12 by the gas pressure sensor 72 and detect a temperature of the fermentation tank 112 by the temperature sensor 16. The control module can determine a degree of fermentation of the beverage by using the detected pressure or temperature.

Also, the controller can detect a temperature of water supplied from the water supply module 5 to the first main channel 41 by using the water supply temperature sensor 57. The controller can control the water supply heater 53 according to the detected temperature of the water.

Also, the controller can control the temperature controller 11 to maintain the temperature of the fermentation tank 112 to an adequate temperature.

Also, the controller can accumulate at least one of a time taken to open the dispenser 62, a time taken to drive the air pump 82, or a time taken to turn on the main valve 40 after the beverage is completely made. The controller can calculate the amount of dispensed beverage that is dispensed from the fermentation container 12 according to the accumulated time. The controller can calculate the amount of residual beverage from the calculated amount of dispensed beverage. The controller can determine whether the beverage within the fermentation container 12 is completely dispensed from the information of the calculated amount of residual beverage. The controller can determine that the beverage is completely dispensed when it is determined that the beverage within the fermentation container 12 is completely dispensed.

In addition, the controller can control an overall operation of the beverage maker. This will be described below in detail.

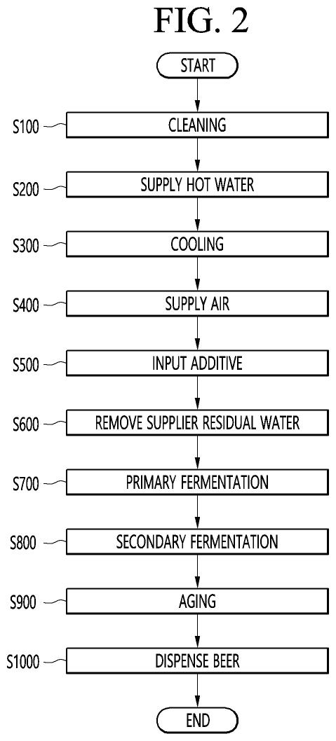

In FIG. 2, the beverage maker can operate in a normal mode.

The normal mode can be a normal mode in which the beverage maker makes a beverage, and the normal mode can be a mode in which a beverage is made according to an algorithm pre-stored in the beverage maker 300 for each recipe of the beverage.

The normal mode can be a mode in which a beverage is made with a preset ingredient, and the made beverage is stored in the beverage maker.

The normal mode is a mode in which a process/operation of transferring the beverage to a separate container is unnecessary. In the normal mode, a user can extract the beverage from the beverage maker to drink the beverage immediately.

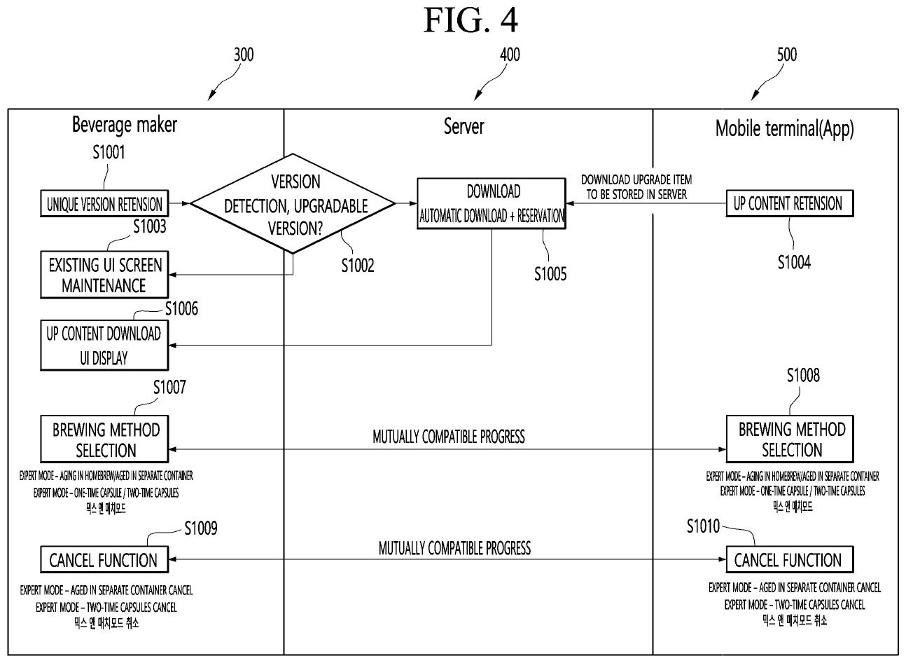

In the normal mode, as illustrated in FIG. 4, the beverage maker can sequentially perform a cleaning process (S100), a water supply process (S200), a fermentation tank cooling process (S300), an air supply process (S400), an additive input process (S500), an ingredient supplier residual water removal process (S600), fermentation processes (S700 and S800), an aging process (S900), and a beverage dispensing process (S1000).

The cleaning process (S100) can be performed separately with respect from the beverage making process. The cleaning process (S100) can be performed before or after the beverage making process. The cleaning process (S100) can be performed after the beverage dispensing process (S1000).

The cleaning process (S100) can also be performed by a user input during the beverage making process. For example, during the primary fermentation process (S700) or the secondary fermentation process (S800), a main valve 40 can be closed, an ingredient supplier 3 may not contain an additive, and the cleaning process (S100) can be performed during the primary fermentation process (S700) or the secondary fermentation process (S800).

The user can input a cleaning command through the input unit, a remote controller, or a mobile terminal. A controller can control the beverage maker to perform the cleaning process (S100) according to the input of the cleaning command.

Also, the user can input a beverage making command through the input unit, the remote controller, or the mobile terminal. The controller can control the beverage maker to perform the cleaning process (S100) before and after the beverage making process according to the input of the beverage making process.

When the cleaning command is inputted through the input unit, the remote controller, or the mobile terminal, the controller can open a beverage dispensing valve 64 and turns on a water supply pump 52 and a water supply heater 53. Also, the controller can control the main valve 40 to be maintained in the closed state. In addition, the controller can open an ingredient supply valve 310 and a bypass valve 35. In addition, the controller can open a sub valve 92.

In the beverage maker, the cleaning can be performed during a cleaning set time. After the cleaning set time, the cleaning process can be completed.

When the cleaning set time elapses, the controller can turn off the water supply pump 52 and the water supply heater 53 to close all of the beverage dispensing valve 64, the bypass valve 35, the ingredient supply valve 310, and the sub valve 92.

Then, the beverage maker 300 can include a beverage making process for making the beverage.

The beverage making process can be performed in a state in which a fermentation container 12 is accommodated in a fermentation tank 112, and capsules C1, C2, and C3 are accommodated in the ingredient supplier 3.

For the beverage making process, the user can open a fermentation lid 107 and insert the fermentation container 12 into the opening 170 to seat the fermentation container 12 on the fermentation module 1.

Thereafter, the user can close the fermentation lid 107, and the inside of the fermentation tank 112 can be closed by the fermentation lid 107.

The user can insert the plurality of capsules C1, C2, and C3 into the ingredient supplier 3 before the fermentation container 12 is seated to cover a plurality of capsule mounting portions 31, 32, and 33 by using a lid module 37.

The user can input the beverage making command through the input unit, the remote controller, or the mobile terminal connected to the controller. The controller can control the beverage maker to perform the beverage making process according to the input of the beverage making command.

The beverage making process can include a water supply process (S200).

In the water supply process (S200), the controller can turn on the water supply pump 52 and the water supply heater 53 and close the ingredient supply valve 310. In the water supply process (S200), the controller can turn off the bypass valve 35 and the main valve 40. In addition, when water is supplied to the fermentation container 12, the controller can turn off an exhaust valve 156.

During the water supply process (S200), a flow meter 56 can detect a water quantity.

The controller can perform the water supply process (S200) until an amount of accumulated water detected by the flow meter 56 reaches a set flow rate, and when an amount of accumulated water detected by the flow meter 56 reaches the set flow rate, the water supply process (S200) can be completed.

When the water supply process (S200) is completed, the controller can turn off the water supply pump 52 and the water supply heater 53 and close the bypass valve 35. When the water supply process (S200) is completed, the controller can close the gas discharge valve 73 and the exhaust valve 156.

The beverage making process can include a fermentation tank cooling process (S300).

The fermentation tank cooling process (S300) can be performed when the water supply process (S200) is completed.

The controller can control the compressor so that the temperature detected by the temperature sensor 16 is maintained at the set temperature (for example, about 35° C.). In more detail, when the temperature detected by the temperature sensor 16 exceeds a compressor turn-on temperature (for example, about 35.5° C.), the controller can turn on the compressor of the refrigerant cycle device 13. When the temperature detected by the temperature sensor 16 is less than a compressor turn-off temperature (for example, about 34.5° C.), the controller can turn off the compressor.

When a temperature of the fermentation container 12 is less than a set temperature in a state in which the refrigerant cycle device 13 is turned off because an external temperature is extremely low. In this case, the controller can turn on the heater 14 disposed in a lower portion of the fermentation tank 112. The controller can turn on the heater 14 when the temperature detected by the temperature sensor 16 is less than a heat turn-on temperature. When the temperature detected by the temperature sensor 16 is less than a heater turn-off temperature, the controller can turn off the heater.

The beverage making process can include an air supply process (S400).

The air supply process (S400) is a process of mixing liquid malt by supplying air into the fermentation container 12.

The air supply process (S400) can start when the temperature detected by the temperature sensor 16 is less than or equal to a compressor off temperature at least once after the fermentation tank cooling process (S300) starts, and a compressor of the refrigeration cycle device 13 is turned on.

The air supply process (S400) can start when the temperature detected by the temperature sensor 16 is equal to or greater than the heater turn-off temperature at least once when the fermentation tank cooling process (S300) starts, and the heater 14 is turned on.

In the air supply process (S400), the controller can turn on the air pump 82 and turn off the bypass valve 35 and the main valve 40. Also, the controller can turn off the gas discharge valve 73 and the exhaust valve 156 and maintain the closed state of the air supply valve 159 and the ingredient supply valve 310.

While the air pump 82 is turned on, air injected into the air injection channel 81 can flow from the first main channel 41 to the second main channel through the bypass channel 43 and then be introduced into the fermentation container 12 by passing through the main valve 40. As described above, the air introduced into the fermentation container 12 can collide with liquid malt to assist the uniform mixing of the heated water and the liquid malt, and the air colliding with the liquid malt can supply oxygen into the liquid malt. That is, the agitation and aeration can be performed.

While the air pump 82 is turned on, the air is mixed with the liquid malt during a mixing set time, the controller can turn on the air pump 82, and the mixing set time elapses, the air supply process (S400) can be completed. When the air supply process (S400) is completed, the controller can turn off the air pump 82 and close the bypass valve 35. In addition, when the air supply process (S400) is completed, the controller can close the gas discharge valve 73 and the exhaust valve 156.

The beverage making process can include the additive input process (S500).

The additive input process (S500) can start after the air supply process (S400).

In the additive input process (S500), the controller can turn on the water supply pump 52 and maintain the turn-off of the water supply heater 53. In addition, the controller can maintain the closing of the bypass valve 35 and open the ingredient supply valve 310 and the main valve 40. In addition, the controller can open the gas discharge valve 73 and the exhaust valve 156.

After the additive input process (S500) starts, when the accumulated flow rate detected by the flow meter 56 reaches an additive input set flow rate, the controller can complete the additive input process (S500). When the additive input process (S500) is completed, the controller can turn off the water supply pump 52.

The beverage making process can further include an ingredient supplier residual water removing process (S600).

The residual water removal process (S600) can be performed after the additive input process (S500) is completed.

In the ingredient supplier residual water removing process (S600), the controller can turn on the air pump 82 and maintain the closing of the air supply valve 159. In addition, the controller can open the ingredient supply valve 310 and the main valve 40. In addition, the controller can open the gas discharge valve 73 and the exhaust valve 156.

The controller can turn on the air pump 82 during the residual water removing set time, and when the residual water removing set time elapses, the ingredient supplier residual water removing process (S600) can be completed.

When the ingredient supplier residual water removing process (S600) is completed, the controller can turn off the air pump 82 and close the ingredient supply valve 310 and the main valve 40. In addition, the controller can close the gas discharge valve 73 and the exhaust valve 156.

When the ingredient supplier residual water removing process (S600) is completed, the controller can display a capsule separation message for informing separation of the capsules C1, C2, and C3 on the display, and the user can remove the empty capsule from the ingredient supplier 3.

The beverage making process can include fermentation processes (S700 and S800).

In the normal mode, the fermentation processes (S700 and S800) can include a primary fermentation process (S700) and a secondary fermentation process (S800), and the primary fermentation process (S700) and the secondary fermentation process (S800) can be sequentially performed after the ingredient supplier residual water removal process (S600) is completed.

According to an example of the primary fermentation process (700), the primary fermentation process (S700) can include a pre-fermentation process and a main-fermentation process. The main-fermentation process can be performed after the pre-fermentation process is completed.

The pre-fermentation process can be a process of quickly and actively activating yeast added into the fermentation container 12 during the additive input process (S500).

In the pre-fermentation process, the controller can control the refrigerant cycle device 13 and the heater 14 so that the temperature measured by the temperature sensor 16 is maintained at a pre-fermentation target temperature (for example, 30° C.). After the pre-fermentation process, the controller can periodically open the gas discharge valve 73 and then close the gas discharge valve 73 to store a pressure value detected by the gas pressure sensor 72 in a storage unit just after the gas discharge valve 73 is closed. The controller can calculate a variation in pressure by comparing the stored pressure value with the pressure value detected after a predetermined time elapses in the gas discharge valve 73 is closed. When the variation in calculated pressure exceeds a pre-fermentation set pressure, the controller can determine that the pre-fermentation is completed, the pre-fermentation process can be completed.

When the pre-fermentation process is completed, the controller can start the main-fermentation process.

In the main-fermentation process, the controller can control the refrigerant cycle device 13 and the heater 14 so that the temperature measured by the temperature sensor 16 is maintained at a main-fermentation target temperature (for example, 21° C.). Here, the main-fermentation target temperature can be higher than the pre-fermentation target temperature.

After the main-fermentation process starts, the controller can periodically open the gas discharge valve 73 and then close the gas discharge valve 73 to store a pressure value detected by the gas pressure sensor 72 in the storage unit while the gas discharge valve 73 is closed. When a variation in pressure that is periodically detected by the gas pressure sensor 72 exceeds the main-fermentation set pressure, the controller can determine that the main-fermentation is completed, and the primary fermentation process (S700) can be completed.

However, the implementations may not be limited to the primary fermentation process (S700). For example, according to another example of the primary fermentation process (S700), the primary fermentation process (S700) may not include the pre-fermentation process but may include only the main-fermentation process.

The controller can start the secondary fermentation process (S800) after the primary fermentation process (S700).

When the secondary fermentation process (S800) is performed, the controller can control the refrigerant cycle device 13 and the heater 14 so that the temperature measured by the temperature sensor 16 becomes a secondary fermentation target temperature.

In the secondary fermentation process (S800), since an inner pressure of the fermentation container 12 is high, if the gas discharge valve 73 is opened, large noise can occur. To solve this limitation, the controller can maintain the closing of the gas discharge valve 73 during the secondary fermentation process (S800) and control opening/closing of the pressure release valve 78 provided with the noise reducing device 77.

After the secondary fermentation process (S800) starts, the controller can periodically open the pressure release valve 76 and then close the pressure release valve 76 to store a pressure value detected by the gas pressure sensor 72 in the storage unit while the pressure release valve 76 is closed. When the variation in pressure that is periodically detected by the gas pressure sensor 72 exceeds a secondary fermentation set pressure, the controller can determine that the secondary fermentation is completed, and the secondary fermentation process (S800) can be completed.

The beverage making process can include an aging process (S900).

The aging process (S900) can be performed when both the primary fermentation process (S700) and the secondary fermentation process (S800) are completed.

In the aging process, the controller can standby for an aging time and control the refrigerant cycle device 13 and the heater 14 so that a temperature of the beverage is maintained between an upper limit value and a lower limit value of a set aging temperature during the aging time.

Since the beverage maker is mainly used in an indoor space, an external temperature of the beverage maker can be maintained between the upper limit value and the lower limit value of the set aging temperature or have a temperature higher than the upper limit value of the set aging temperature. In this case, when the temperature detected by the temperature sensor 16 is less than the lower limit value of the set aging temperature, the controller can turn off the compressor of the refrigerant cycle device 13, and when the temperature detected by the temperature sensor 16 is greater than the upper limit value of the set aging temperature, the controller can turn on the compressor.

Exceptionally, in the case in which the external temperature of the beverage maker is less than the lower limit value of the set aging temperature, the controller can turn on the heater 14 when the temperature detected by the temperature sensor 16 is less than the lower limit value, and the controller can turn off the heater 14 when the temperature detected by the temperature sensor 16 is greater than the upper limit value of the set aging temperature.

When the aging time elapses, the making of the beverage by using the beverage maker can be completed.

The controller can display the completion of the making of the beverage through the display.

The beverage dispensing process (S1000) can be a process of dispensing the beverage of the beverage maker to the outside.

In the beverage dispensing process (S1000), the user can dispense the beverage by manipulating the dispenser 62.

After the beverage is completely made, when the user opens the dispenser 62, the controller can open the main valve 40 and the beverage dispensing valve 64.

When the user closes the dispenser 62, the controller can close the main valve 40 and the beverage dispensing valve 64, and the beverage dispensing process (S1000) can be completed.

When the beverage of the fermentation container is completely dispensed, the controller can display a replacement notification on the display. The user can open the fermentation lid to remove the empty fermentation container 12 from the fermentation tank 112 and insert the separate cleaning pack into the fermentation tank 112. Thereafter, the fermentation lid 107 can be closed.

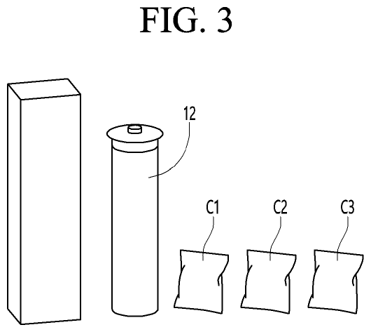

FIG. 3 is a view illustrating the fermentation container and the capsule.

A manufacturer and the like of beverage makers can sell wort, yeast, hop oil, flavor, etc. in a package form, and the fermentation container 12 containing the wort, the first capsule C1 containing the yeast, the second capsule C2 containing the hop oil, and the third capsule C3 containing the flavor can be sold as a capsule package.

The manufacturer and the like can sell an optimal capsule package for each type of beverage, and it is possible to sell the individually components of the capsule. The user who use the beverage maker can freely select the fermentation container 12 and the capsules of the capsule package as desired, and can give the user (customer) the fun of making a special non-standard beverage (my own beverage).

Table 1 shows example recipes for various beverages made by the beverage maker.

TABLE 1

| Classification | IPA | Pale Ale | Stout | Wheat | Pilsner | Red Ale | My Ale | My Lager |
|---|---|---|---|---|---|---|---|---|
| Description | The citrus and | The taste of | The taste of | The soft | The taste of | The taste of | My own ale | My own lager |
| of recipe | tropical fruit | American-style | Irish-style | Belgian-style | Czech-style | heavy and calm | beer may be | beer may be |
| | hop flavors may | beer that is | beer with a | beer taste with | beer in which | ale beer with | made by | made by |
| | be felt, and | not sweet and | rich and dark | a refreshing | is bitter but | the sweet scent | combining | combining |
| | the taste of | easily enjoyed | color, in which | orange scent, | not irritating | of caramel and | beer | beer |
| | American-style | by anyone due | the roast flavor | a spicy | due to the | the savory | ingredients. | ingredients. |
| | beer with | to the harmony | of coffee and | coriander | harmony | taste of nuts | | The cleaner |
| | pleasant | of restrained | dark chocolate | scent, and | of the hop | is pursued. | | taste and |
| | bitterness | American hop | is felt in the | the complex | and malt and | The richer | | aroma may be |
| | is pursued. | flavor and | mouth, and the | taste of malt | the deep taste | taste and | | enjoyed. |
| | | malt caramel | lingering | and wheat | through a long | aroma may | | |
| | | is pursed. | of a creamy | is pursued. | brewing time | be enjoyed. | | |
| | | | aftertaste | | is pursued. | | | |
| | | | savors, | | | | | |
| | | | is pursued. | | | | | |

| | | | | | | | |
|---|---|---|---|---|---|---|---|
| Wort | Hopi | Deep gold | Dark | Wheat | Deep gold | Hopi | When the customers |
| Yeast oil | American ale | American ale | England ale | Weizen | Larger | English ale | are freely combined, |
| Hop oil | Cascade, | Cascade, | Fuggles, | | Hallertau, | Hallertau, | this brewing recipe |
| | Chinook | Fuggles | Goldings | | Citrus | Fuggles | algorithm is selected |
| Flavor | | | | Orange | | | and brewed. Your |
| | | | | flavor, | | | own beer may be |
| | | | | Coriander | | | made by combining |
| | | | | flavor | | | the desired wort and |
| | | | | | | | capsules. The wort |
| | | | | | | | and yeast capsules |
| | | | | | | | are necessary. |

IPA, pale ale, stout, wheat, pilsner, red ale, etc. can be made according to standardized recipes, and my ale, my lager, etc. can be made by non-standard recipes.

My ale, my lager, red ale, and the like can be special menus and be made as my own by freely combining beer ingredients (wort, yeast, hop oil, or flavor) by the customer in addition to the standardized capsule packages, and an algorithm that is capable of being selected during the brewing in the beverage maker can be applied. The customer can optimize and apply any combination of the ingredients by brewing algorithm to make beer.

That is, the beverage maker can make my own ale beer by selecting the beer ingredients, and my own ale beer can be made by selecting malt, hops, and flavor. In addition, the user (customer) can enjoy beer (ale/lager) in a new style by various combinations of the wort and capsules.

Some of the plurality of beverage menus can be menus (i.e., normal menus) displayed on the user interface regardless of updates (upgrades). For example, the IPA menu, the pale ale menu, the stout menu, and the like can be normal menus displayed regardless of the upgrade.

The rest of the plurality of beverage menus can be menus (i.e., upgrade menus or update menus) displayed on the user interface only in the case of the updated (upgraded) beverage maker 300. The my ale menu, the my lager menu, and the spicy IPA menu can be upgrade menus or update menus.

The normal mode and the expert mode can be pre-stored modes in the beverage maker 300, and the upgrade menus (special menu and my menu) such as the my ale menu, the my lager menu, and the spicy IPA menu are pre-stored in the beverage maker 300 or can be a menu upgraded through application update of the mobile terminal 500.

The user can select the upgrade menu (special menu, my menu, and mix and match mode) in the normal mode and can select the upgrade menu (special menu, my menu, mix and match mode) in the expert mode.

In the case of the upgrade menus such as the my ale, the controller can be manufactured by changing conditions of fermentation temperature/fermentation time/pressure/carbonization/aging period/cooling time, etc.) compared to the existing ale series (e.g., pale ale).

For example, if the fermentation temperature is about 25 degrees, and the pressure is about 0.35 bar in the case of the normal mode (ale series), in the case of the my ale, the fermentation temperature and pressure can be changed such as the fermentation temperature of about 21 degrees and the pressure of about 0.5 bar, and thus, the user can make arbitrarily a beverage or mix a beverage while changing the fermentation temperature and pressure, and when the user wants to experience his or her own beverage, the beverage can be provided in an optimal combination.

The user interface of the beverage making system can provide a screen on which the normal menu such as IPA, pale ale, stout, wheat, pilsner, red ale, and my ale and the upgraded upgrade mode such as my ale and my larger are capable of being selected, and the beverage maker can make the beverage with 8 types of algorithms.

The upgrade mode can be a mode updated by the mobile terminal 500 or the server 400. In the upgrade mode, at least one of a fermentation temperature, a time, or a fermentation pressure can be different from that in the normal mode.

The user can purchase a standard capsule package (1 wort, 1 yeast, and 2 hop oils or flavors) and other capsule packs (10 hop oils or flavors) (first step), and the user can freely combine the wort, the yeast, the hop oil, or the flavor (second step) and can select the mix and match mode through the beverage maker or the mobile terminal to execute the brewing (third step).

In the mix and match mode, a plurality of beverages (e.g., my ale and my lager) can be selectively made, and making periods and fermentation temperatures of the plurality of beverages (e.g., my ale and my lager) can be different, respectively.

For example, the my ale made by the mix and match mode can produce beer that enjoys a richer taste and aroma, the making period of the beverage maker 300 can be up to about 15 days, and the fermentation temperature can be about 21° C.

The my lager made by the mix and match mode can be a beer that enjoys a cleaner taste and carbonation, the making period of the beverage maker 300 can be up to about 28 days, and the fermentation temperature can be about 12° C.

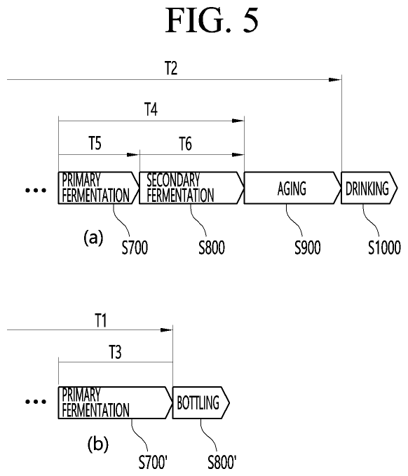

FIG. 4 is a view illustrating an operating state of the beverage making system. FIG. 5 is a view illustrating the making process in the normal mode and the making process in the expert mode.

The beverage making system can include the beverage maker 300 illustrated in FIG. 1, a server 400, and a mobile terminal 500.

The beverage maker 300 can communicate with at least one of the server 400 or the mobile terminal 500.

The mobile terminal 500 can communicate with the server 400.

Each of the beverage maker 300 and the mobile terminal 500 can include a communication module, and one example of the communication module can be a Wi-Fi module.

The beverage making system can include a user interface.

Beverage making information of the beverage made by the beverage maker 300 can be displayed on the user interface. The user interface can receive a user's command through a touch input or the like.

The user interface can be provided to at least one of the mobile terminal 500 or the beverage maker 300.

Another example of the user interface can be a display of the beverage maker 300, and in this case, the display of the beverage maker 300 can include a touch screen that receives a user's command in a touch manner.

Another example of the user interface can be a display of the mobile terminal 500, and in this case, the display of the mobile terminal 500 can include a touch screen that receives a user's command in a touch manner.

Hereinafter, for convenience, the user interface is described as being the display of the mobile terminal 500, but the user interface is not limited to the display of the mobile terminal 500. For example, the user interface can be a displayer provided in the beverage maker 300.

The normal mode (see (a) of FIG. 5) and the expert mode (see (b) of FIG. 5) can be selectively inputted to the user interface.

The user of the beverage maker 300 can input the normal mode or the expert mode through the user interface, and the user can select the beverage making process (normal mode or expert mode).

The user interface can provide at least one mode selection screen, and when the user inputs the normal mode or the expert mode through the mode selection screen, the beverage maker 300 can be controlled according to the selected mode.

The normal mode can be a mode in which the beverage maker 300 ferments a beverage, and the fermented beverage can be aged and stored in the beverage maker 300 and thus can be a simple mode.

The expert mode can be a mode in which the beverage maker 300 makes a beverage through a process different from the normal mode (simple mode) and can be a special mode different from the normal mode (simple mode).

The expert mode can be a mode in which the beverage is made by adjusting fermentation conditions (adding capsules, aging method, fermentation temperature, acidity level, aging period, etc.) to conditions desired by the user (customer).

The expert mode can be a mode in which the beverage maker 300 ferments the beverage to age the fermented beverage in a separate container.

The user can select whether to age the fermented beverage in a separate container or in the beverage maker 300 through the user interface.

In the expert mode, the beverage maker can sequentially perform a cleaning process (S100), a water supply process (S200), a fermentation tank cooling process (S300), an air supply process (S400), an additive input process (S500), an ingredient supplier residual water removal process (S600), fermentation process (S700′), and a bottling process (S800′).

The expert mode can have the same process as the normal mode before the fermentation process (700′), and the fermentation process (S700′) and the bottling process (S800′) can be different from those in the normal mode.

The expert mode can be a mode in which the user directly selects/sets beverage making conditions (e.g., fermentation conditions) to make the beverage.

The expert mode can be an update mode or upgrade mode that is updated (upgraded).

Before making the beverage through the beverage maker 300, the user can select the normal mode and the expert mode.

The user can select and input the expert mode between the normal mode and the expert mode, select a fermentation temperature, select a maturation period, select a secondary capsule input function, or select a storage method after the fermentation.

For example, one of temperatures of 12° C., 18° C., 21° C., and 25° C. can be selected/input as the fermentation temperature.

For example, any one of 2 days (recommended), 3 days, and 4 days can be selected/input as the aging period.

In the secondary capsule input function, one of whether the user secondarily inputs the capsule and whether the user does not secondarily input the capsule can be selected.

The primary capsule extraction can be yeast 1, hop oil or flavor 2, and the secondary capsule extraction can be hop oil or flavor 2.

After the fermentation process, the beverage can be continuously stored by the beverage maker 300 or moved to a separate container and then stored, and whether the beverage maker 300 stores the beverage after the fermentation process and whether the beverage maker 300 stores the beverage in a separate container rather than the beverage maker 300 after the fermentation process can be selected as the storage method after the fermentation.

As described above, the user can select the fermentation temperature, the aging period, the secondary capsule input function, or the storage method after the fermentation, and the user can make a beverage that is different from that in the normal mode.

As described above, when the user completes the selection of the fermentation temperature, the aging period, the secondary capsule input function, and the storage method after the fermentation, the user can confirm that a recipe in the expert mode through the user interface, and thus, the user can confirm the selected setting.

A system for making the beverage can increase in a degree of freedom in the user's bear making, can make beverages in the number of cases customer setting, and can increase in user's enjoyment of using the beverage maker 300.

The beverage making system can further include a controller.

An example of the controller can be the controller of the beverage maker 300, the controller of the server 400, or the controller of the mobile terminal 500, and a combination of the controllers

The controller can control the beverage maker 300 according to the input of the user interface.

The controller can control the user interface, and the controller can selectively perform the normal mode and the expert mode according to the input of the user interface.

The expert mode can be a mode in which the making time of the beverage maker is less than that in the normal mode. That is, a time taken to make the beverage by the beverage maker in the expert mode can be less than that taken to make the beverage by the beverage maker in the normal mode.

The normal mode can be a mode in which the beverage is dispensed (S1000) after the fermentation process (S700 and S800) and the aging process (S900) are sequentially performed.

In the normal mode, as illustrated in (a) of FIG. 5, the beverage maker 300 can perform the fermentation processes (S700 and S800) and the aging process (S900) according to the pre-stored algorithm. After the aging process (S900), the beverage can be dispensed (S1000) and drunk by manipulating the beverage dispenser 6.

The expert mode can be a mode in which the beverage is bottled (S800′; transferring the beverage to the separate container) after the fermentation process (S700′) is performed.

In the expert mode, as illustrated in (b) of FIG. 5, the beverage maker 300 can perform the fermentation process (S700′). After the fermentation process (S700′) is completed, the user can bottle the beverage (S800′). In the expert mode, the user can place the separate container under the beverage dispenser 6, and the beverage on which the fermentation process (S700′) has been completed can move to be stored in the separate container.

An example of the separate container can be a pressure-resistant container that is used exclusively for beer, and sugar for the fermentation can be put into the pressure-resistant container that is used exclusively for beer.

A beverage making time T1 of the beverage maker 300 in the expert mode (see (b) of FIG. 5) can be less than a beverage making time T2 of the beverage maker 300 in the normal mode (see (a) of FIG. 5).

A time T3 of the fermentation process (S700′) in the expert mode can be less than a time T4 of each of the fermentation processes (S700 and S800) in the normal mode.

When bottle work proceeds after the first fermentation by the expert mode, user free fermentation can be possible, and the beverage maker 300 can start new brewing.

As illustrated in FIG. 5, the fermentation process in the normal mode can include the primary fermentation (S700) and the secondary fermentation (S800). On the other hand, the fermentation process in the expert mode includes the primary fermentation (S700′).

The fermentation process in the expert mode can be completed after performing the primary fermentation 700′, and the secondary fermentation may not be performed after the primary fermentation 700′, and then, the user can extract the beverage after the primary fermentation 700′.

The time T3 of the primary fermentation 700′ in the expert mode can be greater than a time T5 of the primary fermentation (S700) in the normal mode.

The time T3 of the primary fermentation 700′ in the expert mode is less than the sum T5+T6 of the time T5 of the primary fermentation (S700) in the normal mode and the time T6 of the secondary fermentation (S800) in the normal mode.

The expert mode as described above can implement a DIY function of the beverage by the flavor addition function and the extraction function after the first fermentation to satisfy the user's needs.

The beverage maker 300, the server 400, and the mobile terminal 500 can communicate with each other, and the user can upgrade the beverage maker 300 through the mobile terminal 500.

The mobile terminal 500 can be a user terminal used by the user of the beverage maker 300.

When an upgrade item is transmitted through the mobile terminal 500, the server 400 can download the upgrade item, and the beverage maker 300 can download the upgrade item from the server 400 so as to be upgraded.

The beverage maker 300 is not limited to include the built-in function when selling the product, and can continuously add new functions.

The beverage maker 300 can have a unique version. (S1001)

The beverage maker 300 or the server 400 can detect the unique version of the beverage maker 300 and can determine whether the unique version is an upgradeable version. (S1002)

If the unique version is not the upgradeable version, the beverage maker 300 can continue to perform the existing function and maintain an existing user interface UI screen. (S1003)

The mobile terminal 500 can include a specific application capable of controlling and managing the beverage maker 300, and the user can input a content to upgrade the beverage maker 300 through the specific application. The mobile terminal 500 can have a content to be upgraded. (S1004)

The server 400 can download an upgrade item (content) from the mobile terminal 500 to store the upgrade item in the server. The server 400 can download automatically or by reservation. (S1005)

If the unique version of the beverage maker 300 is the upgradeable version, the server 400 can transmit the upgrade item (content) to the beverage maker 300, and the beverage maker 300 can download the upgrade item and can display the user interface. (S1006)

The beverage maker 300 and the mobile terminal 500 can be compatible with each other.

When the brewing method is selected in the beverage maker 300, the beverage maker 300 can allow the brewing method to be compatible with the mobile terminal 500, and when the brewing method is selected in the mobile terminal 500, the mobile terminal 500 can allow the brewing method to be compatible with the beverage maker 300. (S10007 and S1008)

Here, an example of the brewing method can include aging in a homebrew (beverage maker 300) in the expert mode or aging in the separate container and can include a process of inputting the capsule once or inputting the capsule twice.

Another example of the brewing method can be the mix and match mode.

When cancel of the brewing method is selected in the beverage maker 300, the beverage maker 300 can allow the cancel of the brewing method to be compatible with the mobile terminal 500, and when the cancel of the brewing method is selected in the mobile terminal 500, the mobile terminal 500 can allow the cancel of the brewing method to be compatible with the beverage maker 300. (S1009 and S1010)

Here, an example of the cancel of the brewing method can include a process of minimizing the aging in the separate container in the expert mode and can include a process of canceling the input of capsules twice.

Another example of canceling the brewing method can be a process of canceling the mix and match mode.

The user interface can display a name of a beverage in the normal mode and a name of a beverage in the mix and match mode together, and the user can select the beverage in the normal mode or the beverage in the mix and match mode through the user interface.

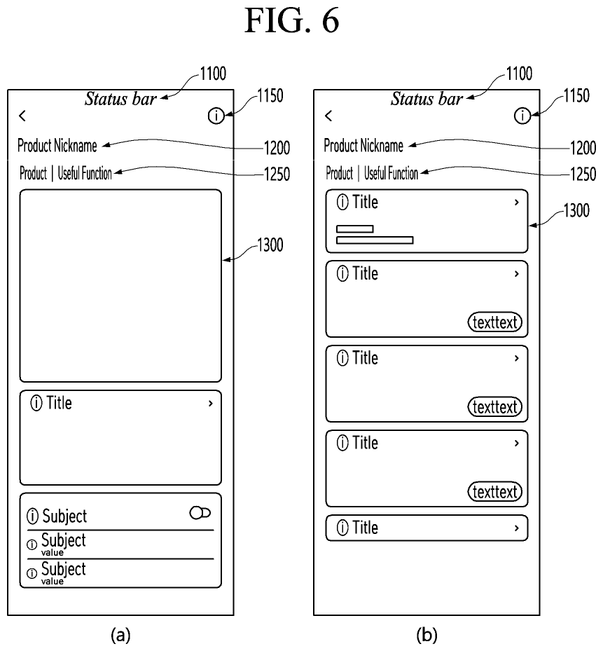

FIG. 6 is a view of the user interface.

The user interface can include a status bar area 1100, an application bar 1150, a title area 1200, a tab area 1250, and a main area 1300.

A phrase such as “status bar” can be displayed on the status bar area 1100.

An icon of ‘<’ and a basic button can be displayed on the application bar 1150. The ‘<’ icon can be a back button.

A product nickname can be displayed on the title area 1200.

The tab bar can be displayed on the tab area 1250, and a phrase such as ‘product/useful function’ can be displayed on the tab bar. In addition, the user can touch-input ‘product’ among the ‘product/useful function’ or can touch-input the ‘useful function’.

The user interface can provide a screen for the user to select the “product/useful function,” and when the user taps the “product,” the user interface can provide a screen related to the “product” as shown in (a) of FIG. 6, and when the user taps the “useful function,” the user interface can provide a screen related to the “useful function” as illustrated in (b) of FIG. 6.

The screen related to the “product” can be a screen for manipulating a frequently used function, main control/monitoring information can be boldly placed on an upper portion of the screen, and detailed manipulation of the product can be provided by chunking on a lower portion of the screen.

Although the “useful function” is hidden, it can be a screen that is capable of improving accessibility of the useful function, and information can be visualized so that most of the status is grasped without entering the menu of services/contents and additional functions.

When the products/useful functions are divided as described above, effectiveness of using the product increases, and sufficient information can be provided to the user.

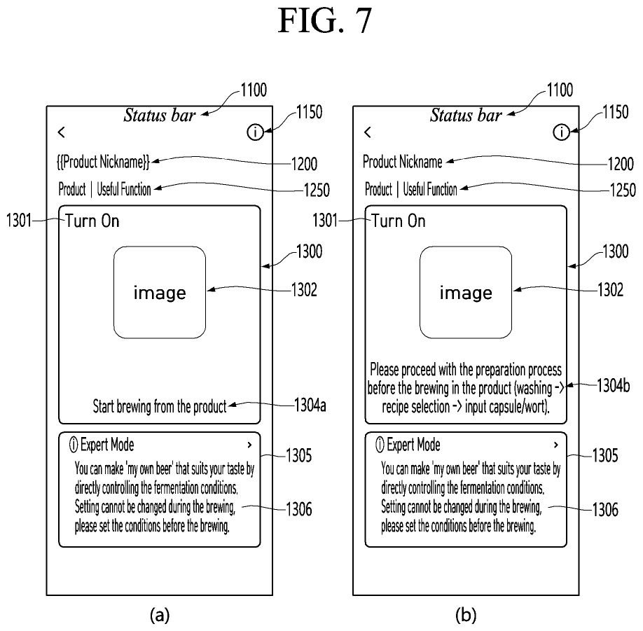

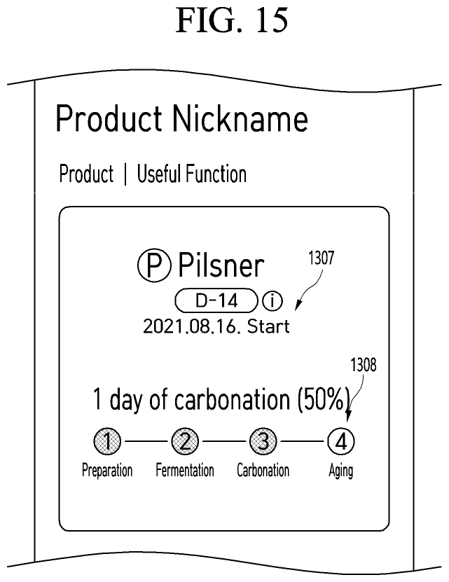

FIG. 7 illustrates the user interface when the ‘product’ among the products/useful functions is tapped (touch-inputted) or when the ‘product’ is set as default, and FIG. 15 illustrates the user interface when the ‘useful functions’ among products/useful functions is tapped (touch-inputted).

FIG. 7 is a view when the user interface taps a product.

(a) of FIG. 7 is a view illustrating the user interface when the beverage maker is on standby, and (b) of FIG. 7 is a view illustrating the user interface when the beverage maker is preparing.

When the user taps the ‘product’, and the beverage maker is on standby, as illustrated in (a) of FIG. 7, the user interface can include a status bar area 1100, an application bar 1150, a title area 1200, a tab area 1250, and a main area 1300.

A product status phrase 1301 such as ‘on’, an image of the beverage maker 1302, and a guide text 1304a indicating a standby state such as ‘Please start brewing in the product’ can be displayed on the main area 1300.

An expert mode card 1305 can be further displayed on the main area 1300. The expert mode card 1305 can be displayed together with a guide phrase of “expert mode,” an icon such as ‘>’, and a guide text 1306 can be provided together.

The icon such as ‘>’ can be an entry button or a selection button.

The guide text 1306 can be a text that explains the expert mode and guides notes of the expert mode.

An example of the guide text 1306 is a text such as “You can make ‘my own beer’ that suits your taste by directly controlling the fermentation conditions. Setting cannot be changed during brewing. Please set the conditions before the brewing.”

When the beverage maker is preparing, the user interface can include a status bar area 1100, an application bar 1150, a title area 1200, a tab area 1250, and a main area 1300. In the area 1300, as illustrated in (b) of FIG. 7, a guide text 1304b indicating that the beverage maker is being prepared can be changed.

When the beverage maker is preparing, an example of the guide text 1304b can be a text such as “Please proceed with the preparation process before the brewing in the product (washing->recipe selection->input capsule/wort).”

When the beverage maker is preparing, the user interface is different from the guide text 1304a of the user interface when the text of the guide text 1304b is on standby, and others 1100, 1150, 1200, 1250, 1301 1302, 1305, and 1306 can be the same as the user interface during the preparation.

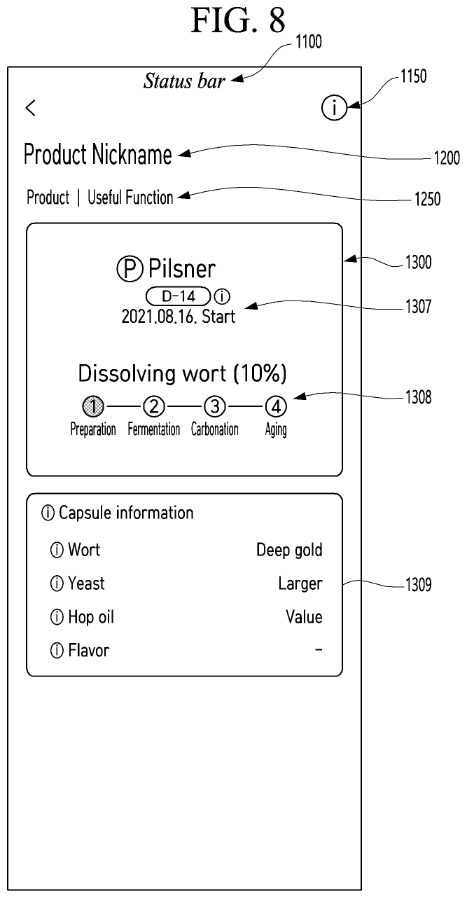

FIG. 8 is a view illustrating the user interface from which the beverage is extracted in the expert mode in the beverage making system.

The brewing process in the normal mode can include a total of 4 steps, i.e., a process in preparing, which is a first step, a process in fermenting (fermentation start (0%)-fermentation completion (100%)), which is a second step, a process in carbonating (carbonation start (0%)-carbonation completion (100%)), which is a third step, and a process in aging (aging start (0%)-aging completion (100%)), which is a fourth step.

The process in preparing can include a process in ‘dissolving wort’, a process in ‘stabilizing a temperature’, and a process in ‘extracting a capsule’.

When the beverage maker prepares a beverage in the normal mode, as illustrated in FIG. 8, the user interface can include a status bar area 1100, an application bar 1150, a title area 1200 and a tab area 1250, and a main area 1300, and the main area 1300 can display at least one brewing information 1307 and 1308 and a capsule information card 1309.

When the beverage maker makes a beverage in the normal mode, the status bar area 1100, the application bar 1150, the title area 1200, and the tab area 1250 can be the same as when the beverage maker is on standby or preparing, and only the main area 1300 can be different.

In the normal mode, the main area 1300 can display at least one brewing information 1307 and 1308 and a capsule information card 1309 as illustrated in FIG. 8.

The at least one brewing information 1307 and 1308 can be provided in plurality, and first brewing information 1307 of the plurality of brewing information 1307 and 1308 can include an icon and a beer name (e.g., pilsner). The first brewing information 1307 can include a remaining time (e.g., D−14) and a tip icon. The tip icon can be displayed next to the remaining time.

The first brewing information 1307 can include a making start date, and the making start date can be displayed in the order of year, month, and day.

The first brewing information 1307 can be expressed in the same manner as in the case of the normal mode and the case of the expert mode.

A portion of the second brewing information 1308 of the plurality of brewing information 1307 and 1308 can be different between the normal mode and the expert mode.

The second brewing information 1308 of the plurality of brewing information 1307 and 1308 in the normal mode can include a color and image for each beer and can include an icon of a beer being made.

The second brewing information 1308 can include a making status (e.g., in dissolving wort) and a progress rate (e.g., about 10%). The second brewing information 1308 can include a brewing process.

An example of the process in ‘fermenting’, the process in ‘carbonizing’, and the process in ‘aging’ can be displayed together with the current status, the number of days, and the progress rate, for example, can be displayed such as 50% in the second day of fermentation, and 0 hour to about 23 hours can be displayed as first day, and about 24 hours 1 second to about 48 hours can be displayed as the second day.

Other examples of the process in ‘fermenting’, the process in ‘carbonating’, and the process in ‘aging’ can be displayed together with the current status and the progress rate, for example, fermenting 50%.

An icon and an option value of a plurality of ingredients (wort/yeast/hop/flavor) can be displayed on the capsule information card 1309 in the normal mode. The capsule color and shape can be fixed, the option value can be displayed in one line, and an ellipsis (e.g., *) can be included when the option value exceeds the range. If there is no capsule information, ‘-’ can be displayed.

Special menus (upgrade menus) such as my ale and my lager can be made in the mix and match mode, and in the mix and match mode, the main area of the user interface can display the first brewing information 1307.

In the mix and match mode, the status bar area 1100 the application bar 1150, the title area 1200, and the tab area 1250 other than the main area 1300 can be the same as the normal mode.

In the mix and match mode, the first brewing information 1307 can be expressed in the same manner as in the normal mode except for the beer name. The first brewing information 1307 can include an icon and a beer name (e.g., my recipe). The first brewing information 1307 can include a remaining time (e.g., D−14) and a tip icon. The tip icon can be displayed next to the remaining time. The first brewing information 1307 can include a making start date, and the making start date can be displayed in the order of year, month, and day.

In the mix and match mode, the second brewing information 1308 can be the same as in the normal mode.

Like the normal mode, the brewing process in the mix and match mode can include a total of 4 steps, i.e., as illustrated in FIG. 8, a process in preparing, which is a first step, a process in fermenting (fermentation start (0%)-fermentation completion (100%)), which is a second step, a process in carbonating (carbonation start (0%)-carbonation completion (100%)), which is a third step, and a process in aging (aging start (0%)-aging completion (100%)), which is a fourth step, and the process in preparing can include a process of ‘dissolving wort’, a process of ‘temperature stabilization’, and a process of ‘during capsule extraction’.

The second brewing information 1308 of the plurality of brewing information 1307 and 1308 in the mix and match mode can include a color and image for each beer and can include an icon of a beer being made.

The second brewing information 1308 can include a making status (e.g., in dissolving wort) and a progress rate (e.g., about 10%). The second brewing information 1308 can include a brewing process.

An example of the process in ‘fermenting’, the process in ‘carbonizing’, and the process in ‘aging’ can be displayed together with the current status, the number of days, and the progress rate, for example, can be displayed such as 50% in the second day of fermentation, and 0 hour to about 23 hours can be displayed as first day, and about 24 hours 1 second to about 48 hours can be displayed as the second day.

Other examples of the process in ‘fermenting’, the process in ‘carbonating’, and the process in ‘aging’ can be displayed together with the current status and the progress rate, for example, fermenting 50%.

On the other hand, if the user inputs a tip icon displayed next to the remaining time (e.g., D−14) among the first brewing information 1307, the user interface can display guide text that guides notes for the special mode, that is, the mix and match mode. An example of the guide text in the mix and match mode can include a phrase such as “The remaining time can be changed because a fermentation speed is different by applying various mixtures of wort, yeast, hop oil, and flavor according to the user's taste.”

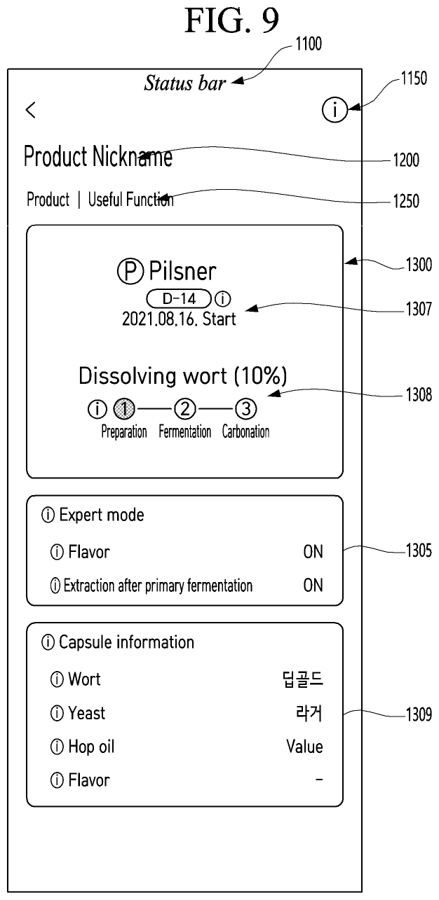

FIG. 9 is a view illustrating the user interface when the beverage maker makes a beverage in the expert mode.

The brewing process in the expert mode can include a total of 3 steps, i.e., a process in preparing, which is a first step, a process in fermenting (fermentation start (0%)-fermentation completion (100%)), which is a second step, and a process in bottling (fermentation completion (100%)), which is a third step, and the process in preparing can include a process of ‘dissolving wort’, a process of ‘temperature stabilization’, and a process of ‘during capsule extraction’.

When the beverage maker prepares a beverage in the normal mode, as illustrated in FIG. 9, the user interface can include a status bar area 1100, an application bar 1150, a title area 1200, a tab area 1250, and a main area 1300, and the main area 1300 can display at least one brewing information 1307 and 1308, an expert mode card 1305, and a capsule information card 1309.

When the beverage maker makes a beverage in the expert mode, the status bar area 1100, the application bar 1150, the title area 1200, and the tab area 1250 can be the same as when the beverage maker is on standby or preparing, and only the main area 1300 can be different.

First brewing information 1307 of the plurality of brewing information 1307 and 1308 in the expert mode can be expressed in the same manner as the first brewing information in the normal mode.

That is, the at least one brewing information 1307 and 1308 can be provided in plurality, and first brewing information 1307 of the plurality of brewing information 1307 and 1308 can include an icon and a beer name (e.g., pilsner). The first brewing information 1307 can include a remaining time (e.g., D−14) and a tip icon. The tip icon can be displayed next to the remaining time. The first brewing information 1307 can include a making start date, and the making start date can be displayed in the order of year, month, and day.

The second brewing information 1308 of the plurality of brewing information 1307 and 1308 in the expert mode can include a color and image for each beer and can include an icon of a beer being made.

The second brewing information 1308 can include a making status (e.g., in dissolving wort) and a progress rate (e.g., about 10%). The second brewing information 1308 can include a brewing process.

An example of the process in fermenting can be displayed together with the current status, the number of days, and the progress rate, for example, can be displayed such as 50% in the second day of fermentation, and 0 hour to about 23 hours can be displayed as first day, and about 24 hours 1 second to about 48 hours can be displayed as the second day.

Other examples of the process in fermenting can be displayed together with the current status and the progress rate, for example, fermenting 50%.

In the expert mode, the expert mode card 1305 can be displayed between the at least one brewing information 1307 and 1308 and the capsule information card 1309 as illustrated in FIG. 9.

The expert mode card 1305 is not displayed in the normal mode, but can be displayed only in the expert mode.

The expert mode card 1305 can display a set state expressing the set state of the expert mode (e.g., flavor addition ON, extraction after the primary fermentation ON), and the on state can be displayed.

Like the normal mode, an icon and an option value of a plurality of ingredients (wort/yeast/hop/flavor) can be displayed on the capsule information card 1309 in the expert mode. The capsule color and shape can be fixed, the option value can be displayed in one line, and an ellipsis (e.g., *) can be included when the option value exceeds the range. If there is no capsule information, ‘-’ can be displayed.

The remaining time displayed in the normal mode as illustrated in FIG. 8 and the remaining time displayed in the expert mode as illustrated in FIG. 9 can be displayed as a date, a time, or a combination of hours and minutes. For example, if about 36 hours to about 14 days remain, the remaining time for each day can be displayed as D-Day (e.g., D−14), if about 1 hour to about 36 hours remain, the remaining time for each hour can be displayed as HH;00 (e.g., 36;00 or 35;00), and if about 0 second to about 1 hour remain, the remaining time can be displayed as HH;MM (e.g., 01;00 or 00;59).

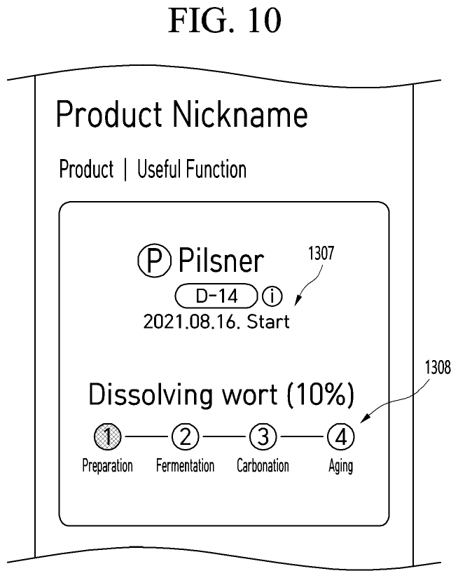

FIGS. 10 to 17 are a view illustrating various displays due to a state in which the beverage is made.

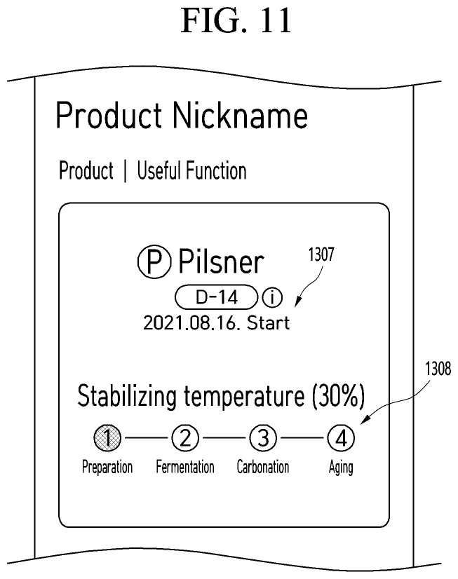

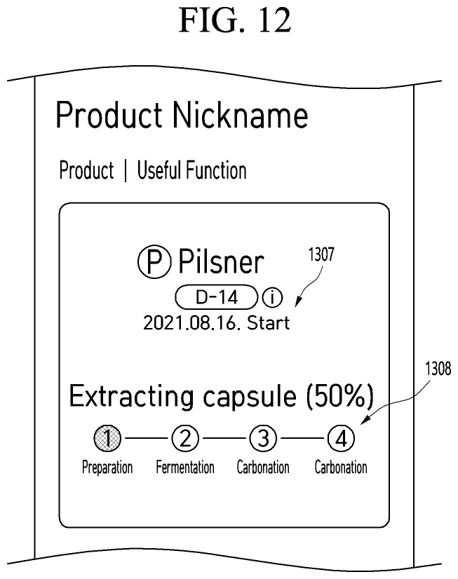

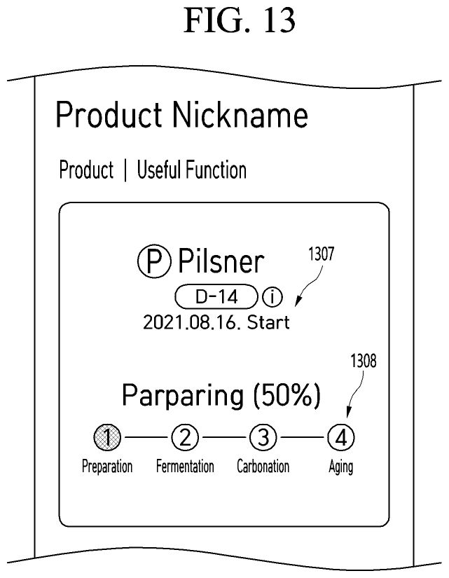

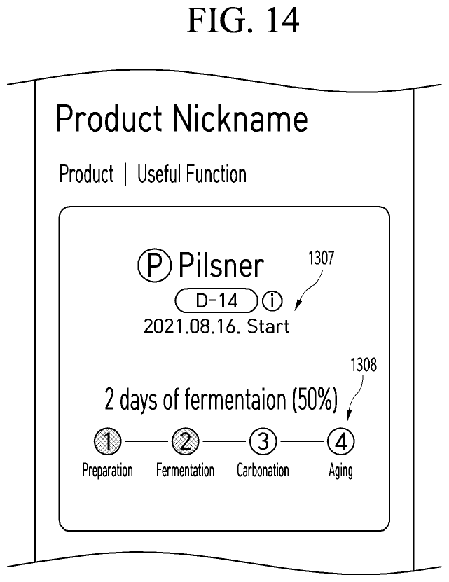

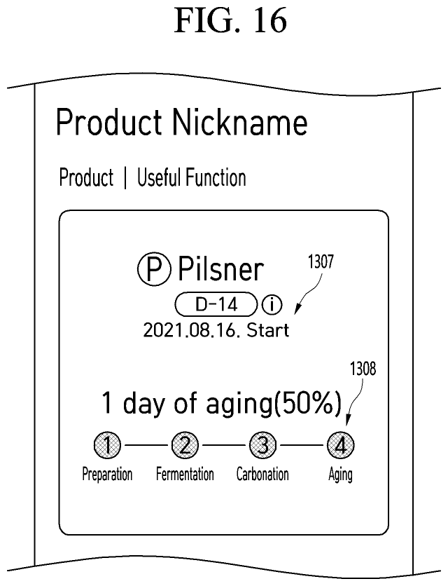

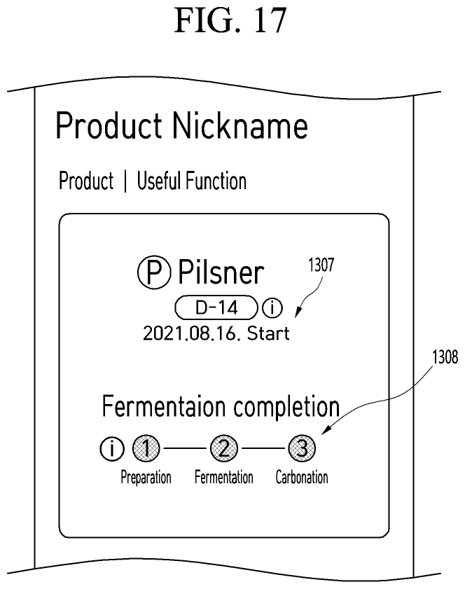

FIG. 10 is a view during the wort dissolution in making preparation, FIG. 11 is a view during the temperature stabilization in making preparation, FIG. 12 is a view during the capsule extraction in making preparation, FIG. 13 is a view during the preparation in making preparation, FIG. 14 is a view during the wort dissolution in making preparation, FIG. 15 is a view during the carbonation in making preparation, FIG. 16 is a view during the aging in making preparation, and FIG. 17 is a view during the fermentation completion in making preparation.

A making state such as in preparation (50%) illustrated in (FIG. 13 can be displayed when the entire process is unknown.

As illustrated in FIGS. 10 to 17, the user interface can display each making status in the normal mode (e.g., preparing, fermenting, carbonating, and aging) and each progress rate (e.g., about 10%), and the making status (e.g., fermentation completed) in the expert mode can be displayed.

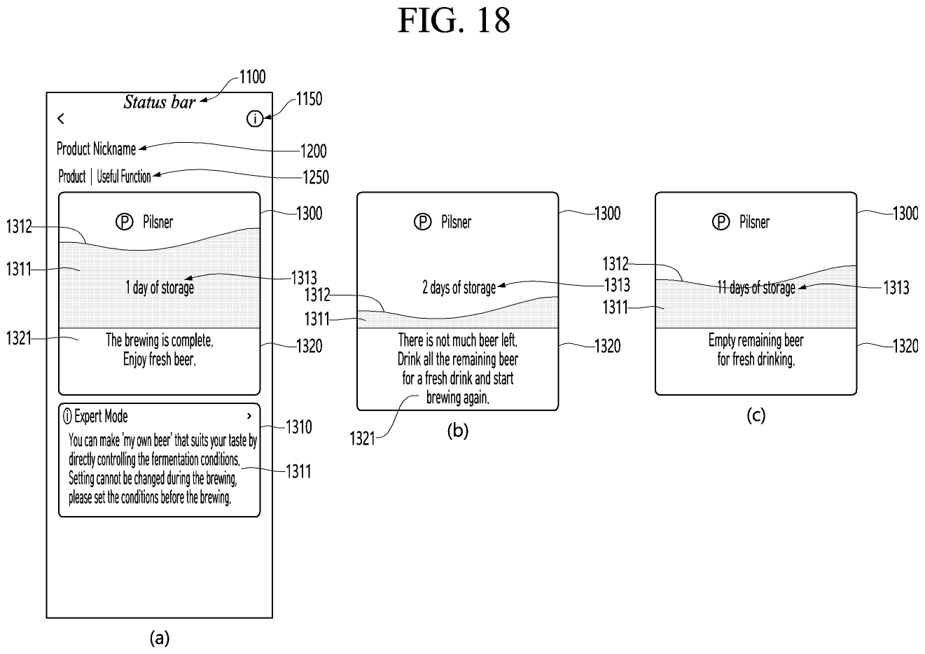

FIG. 18 is a view illustrating the user interface when the beverage maker stores a beverage.

(a) of FIG. 18 illustrates the user interface when a storage period is less than about 10 days, and a remaining amount of beverage exceeds about 10%, (b) of FIG. 18 illustrates the main area of the user interface when a storage period is less than about 10 days, and a remaining amount of beverage less than about 10%, and (c) of FIG. 18 illustrates the main area of the user interface when a storage period is equal to or greater than about 10 days.

The user interface can display a status bar area 1100, an application bar 1150, a title area 1200, a tab area 1250, a main area 1300, and a guide area 1320 when the beverage maker stores a beverage.

The status bar area 1100, the application bar 1150, the title area 1200, and the tab area 1250 can be the same as when the beverage maker makes the beverage.

Brewing information can be displayed on the main area 1300. The brewing information can include an image 1311 and a storage period 1313.

The image 1311 can include a color, and the color of the image 1311 can be designated for each type of beer. A height of the image 1311 can correspond to the remaining amount of beverage currently remaining in the beverage maker. When the remaining amount of beverage remaining in the beverage maker is large, a height of an upper limit 1312 of the image 1311 can be high, and when the remaining amount of beverage remaining in the beverage maker is small, a height of the upper limit 1312 of the image 1311 can be low.

The storage period 1313 can indicate a date being stored as a text. For example, texts such as storage 1 day, storage 2 days, storage 11 days, and the like can be displayed.

A guide text 1321 according to the storage period and remaining amount can be displayed on the guide area 1320. The guide text 1321 can be a text that recommends emptying of the remaining beverage regardless of the remaining amount of beverage when the storage period is longer than a set period (e.g., about 10 days).

The guide text 1321 can include a text such as “The brewing is complete. Enjoy fresh beer” when the storage period is less than about 10 days, and the remaining beverage exceeds about 10%.

The guide text 1321 can include a text such as “There is not much beer left. Drink all the remaining beer for a fresh drink and start brewing again.” when the storage period is less than about 10 days, and the remaining beverage is less than about 10%.

The guide text 1321 can include a text such as “Empty remaining beer for fresh drinking.” when the storage period exceeds 10 days.

The user interface can display the expert mode card 1305 in addition to the main area 1300 and the guide area 1320. In the expert mode card 1305, a text such as the ‘expert mode’ and a′>′ icon can be displayed together, and the guide text 1321 can be provided together. An example of the guide text 1321 displayed on the expert mode card 1305 can include a text such as “You can make ‘my own beer’ that suits your taste by directly controlling the fermentation conditions. It can be a text such as “setting cannot be changed during the brewing, please set the conditions before the brewing.”

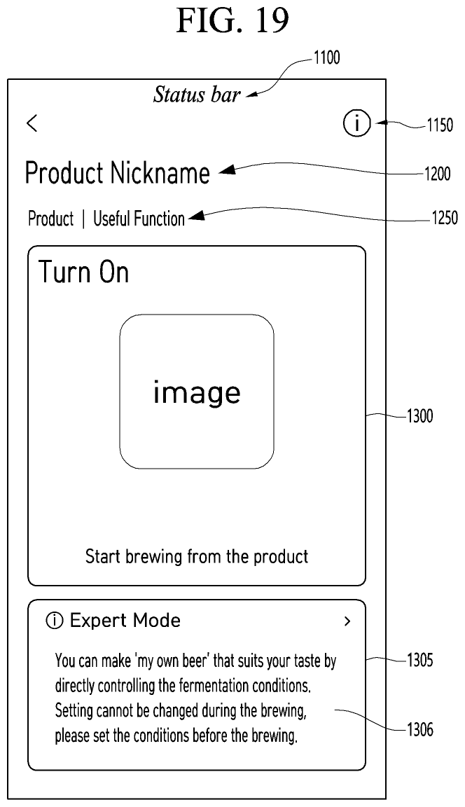

FIGS. 19 to 22 are a view illustrating a process of entering the expert mode through the user interface.

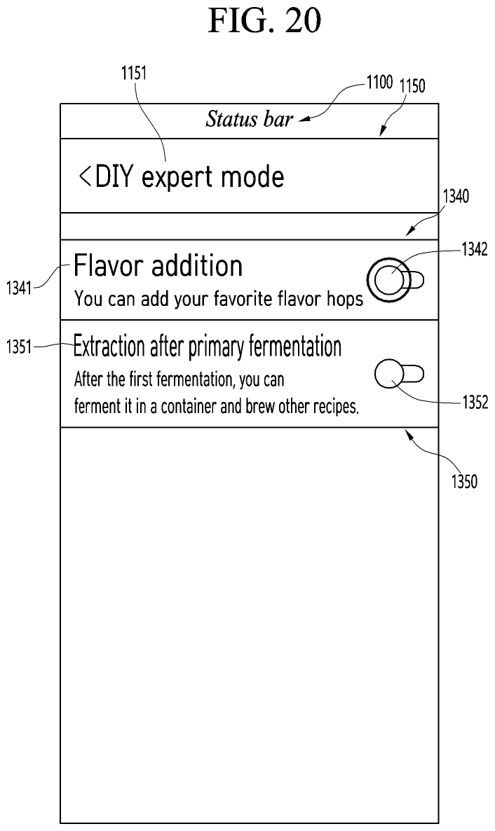

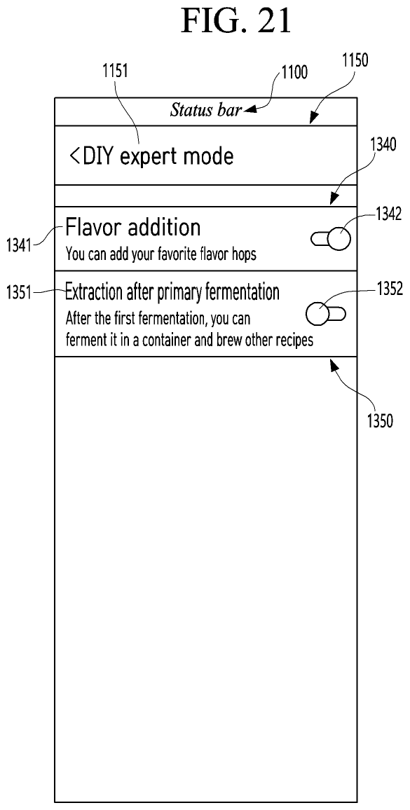

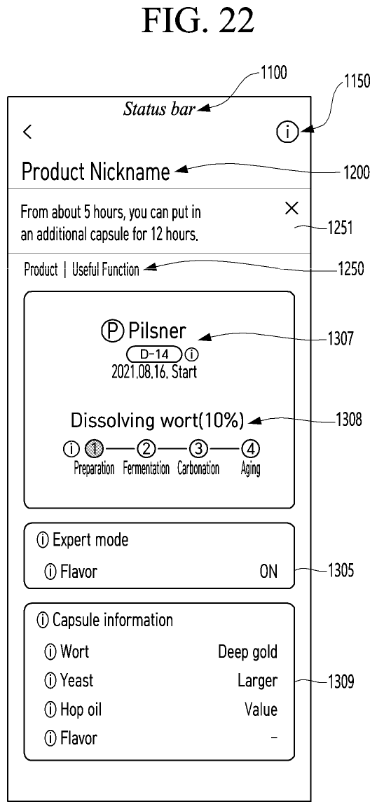

FIG. 19 is a view when the user inputs the expert mode while the beverage maker is on standby, FIG. 20 is a view when the user interface displays the conditions of the expert mode, FIG. 21 is a view when the user turns on a flavor addition function, and FIG. 22 is a view illustrating the user interface when the beverage maker is preparing for the expert mode.

The expert mode can be inputted while the beverage maker is on standby, and the user can input the ‘>’ icon in the expert mode card 1305 of the user interface illustrated in (a) of FIG. 7 and FIG. 19.

When the user inputs the ‘>’ icon in the expert mode card 1305, the user interface can be changed to input each condition of the expert mode as illustrated in FIG. 20. The user interface can display a phrase 1151 such as DIY expert mode on the application bar 1150, and the user interface can display at least one condition input screen 1340 or 1350 of the expert mode.

The condition input screens 1340 and 1350 can be created below the application bar 1150, that is, under the phrase 1151 such as the DIY expert mode.

The plurality of condition input screens 1340 and 1350 can be created, and the plurality of condition input screens 1340 and 1350 can include a flavor addition screen 1340 and an extraction screen 1350 after primary fermentation.

The flavor addition screen 1340 can include a flavor addition phrase 1341 and a switch 1342 capable of turning on/off the flavor addition function.

The extraction screen 1350 after the primary fermentation can include a post-primary fermentation extraction phrase 1351 and a switch 1352 capable of turning on/off the post-primary fermentation extraction function.

As illustrated in FIG. 20, the user can turn on the flavor addition function by pushing the switch 1342, which is in an off state, to a right side as illustrated in FIG. 21.

As described above, when the flavor addition function is turned on, the user interface can display whether to add the flavor on the expert mode card 1305 as ON when the expert mode is being prepared, as illustrated in FIG. 22.

When the expert mode is being prepared, the user interface can create a notification card including a text 1251 for guiding notes of the expert mode, as illustrated in FIG. 22.

The text 1251 and the notification card can be created between the title area 1200 and the tab area 1250.

An example of such the text 1251 can be a text such as “From about 5 hours, you can put in an additional capsule for 12 hours.”

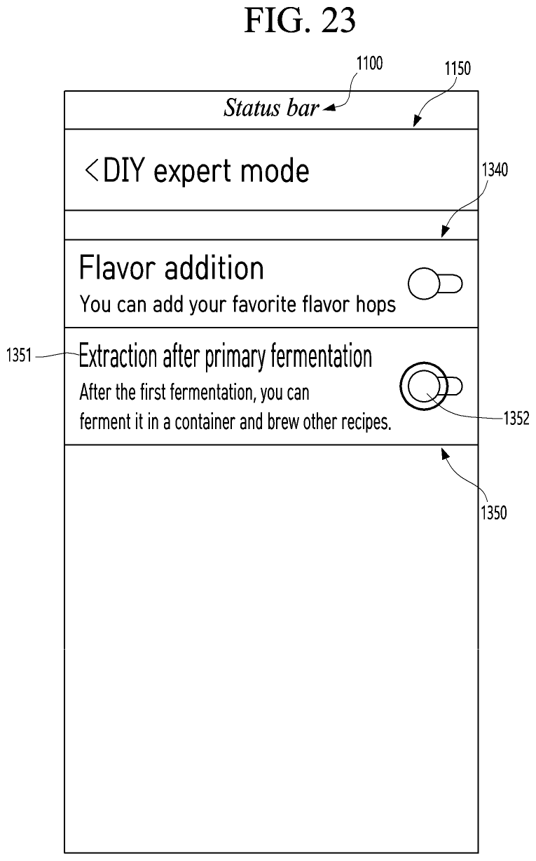

FIGS. 23 to 26 are a view illustrating a process of inputting the extraction after the primary fermentation in the expert mode through the user interface.

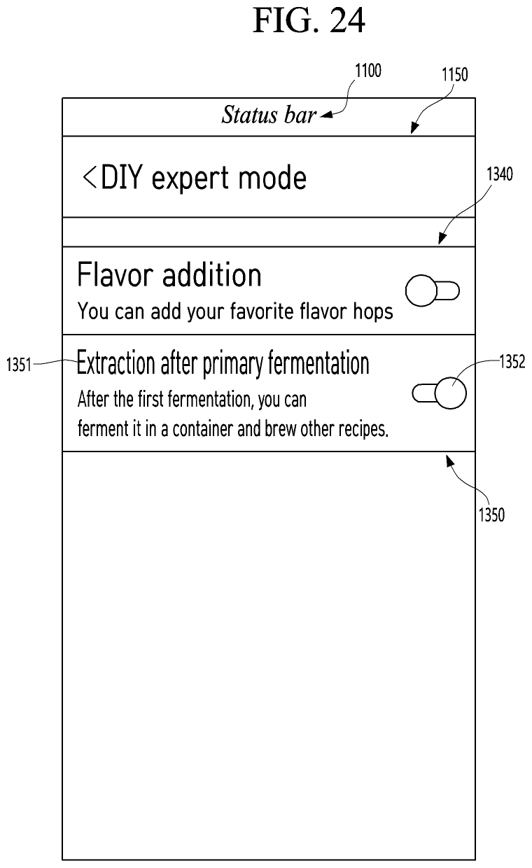

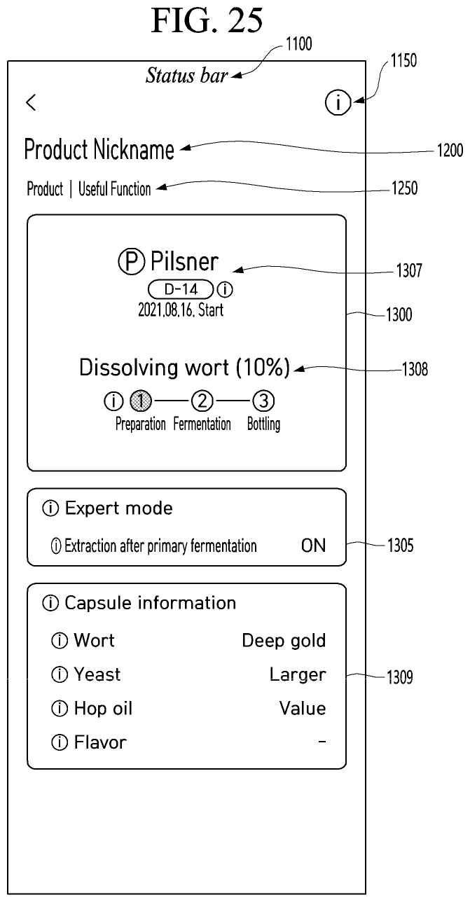

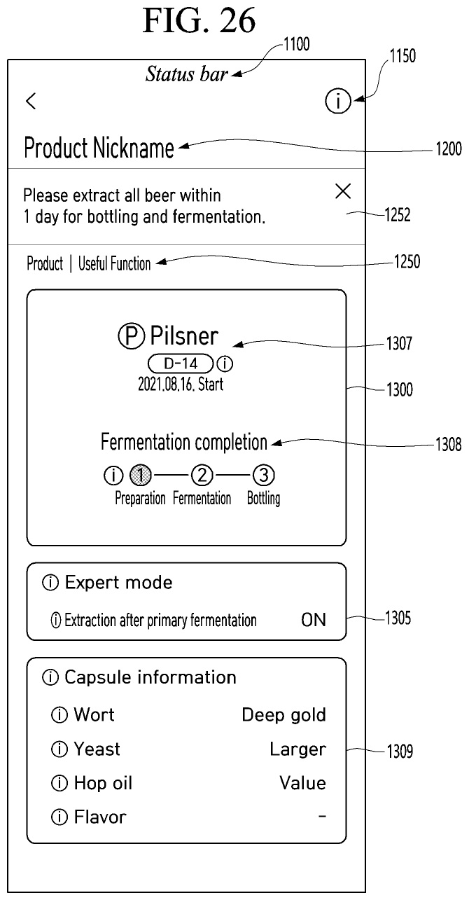

FIG. 23 is a view when the user interface displays the expert mode conditions, FIG. 24 is a view when the user turns on the extraction function after the primary fermentation, FIG. 25 is a view illustrating the user interface when the beverage maker is preparing for the expert mode, and FIG. 26 is a view when the user interface provides a primary notification message for bottling fermentation when the fermentation in the expert mode is completed (primary fermentation is completed).

As illustrated in FIG. 23, the user can turn on the extraction function after the primary fermentation by pushing the switch 1352, which is in an off state, to a right side as illustrated in FIG. 24.

As described above, when the extraction function after the primary fermentation is turned on, the user interface can display whether to perform the extraction function after the primary fermentation on the expert mode card 1305 as ON when the expert mode is being prepared, as illustrated in FIG. 22.

In addition, as illustrated in FIG. 23, the user interface can indicate whether to perform the extraction after the primary fermentation on the expert mode card 1305 after the fermentation in the expert mode is completed and before the bottling starts, and the notification card including the primary notification message 1252 can be created.

The primary notification message 1252 can be created between the title area 1200 and the tab area 1250.

The first notification message 1252 can include a text inducing the user to the bottling and can include, for example, a text such as “Please extract all beers for bottling and fermentation.”

When the set day (e.g., 1 day) elapses in a state in which the user does not start the bottling after the start of the bottling, the user interface can provide a secondary message, and when the bottling starts within 1 day after the start of the bottling, the user interface may not provide the secondary message.

The secondary message can be a text that induces the user to re-bottle and can include, for example, a text such as “Please extract all beer within 1 day for bottling and fermentation.”

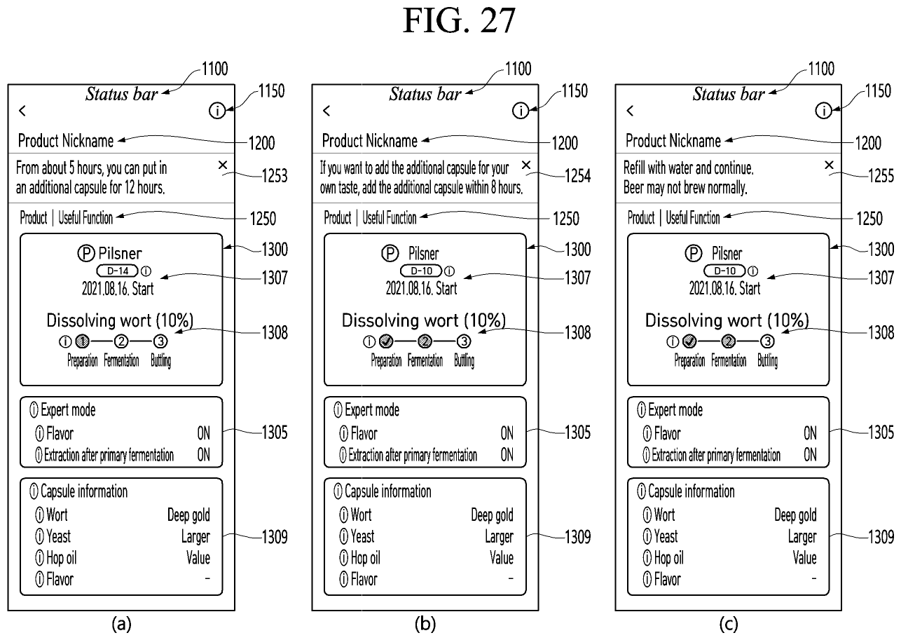

FIG. 27 is a view illustrating a state when the user interface displays the notification card in the expert mode.

The user interface can display at least one notification card. The notification card can be created between the title area 1200 and the tab area 1250.

As illustrated in (a) of FIG. 27, an example of the notification card can include a message 1253 guiding adding a flavor capsule at the start of brewing, for example, a message such as “After about 5 hours, you can put in the additional capsule for 12 hours.”

As illustrated in (b) of FIG. 27, another example of the notification card can include a message 1254 guiding the addition of the flavor capsule at the actual time of adding the flavor capsule, for example, a message such as “If you want to add the additional capsule for your own taste, add the additional capsule within 8 hours.”

As illustrated in (c) of FIG. 27, the other example of the notification card can include a message 1255 for guiding water replenishment when water is insufficient during the brewing, for example, a message such as “Refill with water and continue. Beer may not brew normally.”

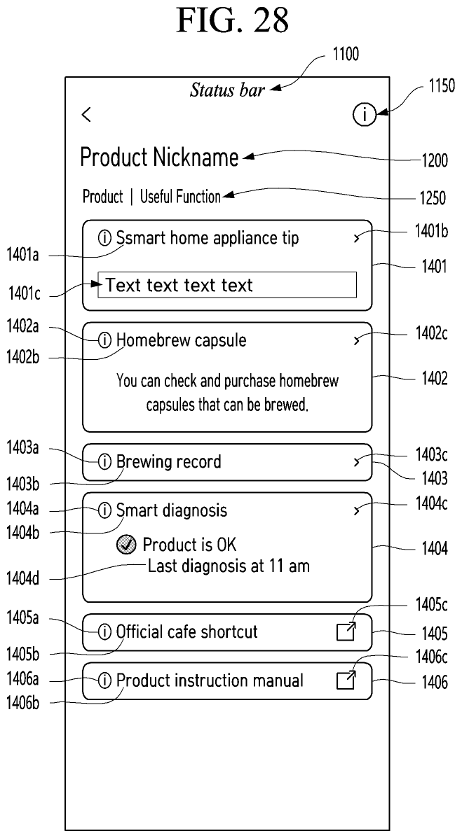

FIG. 28 is a view illustrating a tab when a useful function of the user interface is tapped.

The user can touch-input the ‘useful function’ in the tab area 1250, and the user interface can create the useful function card when the ‘useful function’ in the tab area 1250 is inputted.

The useful function card can be a card capable of checking or setting various functions of the beverage making system, and the user interface can provide at least one useful function card.

At least one useful function card can include a smart home appliance tip card 1401, a homebrew capsule card 1402, a brewing record card 1403, a smart diagnosis card 1404, an official cafe shortcut card 1405, and a product instruction manual card 1406.

The smart home appliance tip card 1401 can display an extracted content title. The smart home appliance tip card 1401 can include a title 1401a such as a ‘smart home appliance tip’ and a ‘>’ icon 1401b. When the user taps the ‘>’ icon 1401b, the user interface can move to a separate page such as a smart life main page. The smart home appliance tip card 1401 can include a content area 1401c, and when the user taps the content area 1401c, the user interface can move to a corresponding content page.

The homebrew capsule card 1402 can include a function icon 1402a, a title 1402b such as a ‘homebrew capsule’, and a ‘>’ icon 1402c. When the user taps the ‘>’ icon 1402c, the user interface can move to a homebrew capsule list screen and provide a guide.

The brewing record card 1403 can include a function icon 1403a, a title 1403b such as ‘Brewing record’, and a ‘>’ icon 1403c. When the user taps the ‘>’ icon 1403c, the user interface can move to a brewing record described later.

The smart diagnosis card 1404 can include a function icon 1404a, a title 1404b such as ‘smart diagnosis’, and a′>′ icon 1404c.

The smart diagnosis card 1404 can include a text 1404d capable of displaying a summary of the latest smart diagnosis. An example of the text 1404d can include a text that allows the user to check the normality/error of the product such as ‘Product is OK’ or ‘Product verification is required’ and a text that allows the user to see when the product has been diagnosed such as ‘Last diagnosis at 11 am’.

When the user taps the ‘>’ icon 1404c of the smart diagnosis card 1404, the user interface can be changed to a smart diagnosis scenario.

The official cafe shortcut card 1405 can include a function icon 1405 a, a title 1405b such as ‘official cafe shortcut’, and an application movement icon 1405c. When the user taps the application move icon 1405c, the user can move to a beverage maker's official cafe.

The product instruction manual card 1406 can include a function icon 1406a, a title 1406b such as ‘product instruction manual’, and an application movement icon 1406c. The beverage maker may or may not enable product identification.

If the product identification is possible, when the user taps the application move icon 1405c and the product user manual application is installed on the mobile terminal or beverage maker, the user interface can move to a manufacturer's product user manual application. The manufacturer's product user manual application can include a my manual item and a corresponding product manual item.

If the product identification is possible, and the user taps the application move icon 1405c, but the manufacturer's product instruction manual application has not yet been installed in the mobile terminal or beverage maker, the user interface can move to a user manual application download screen of a terminal market (e.g., an application store). The user manual application download screen can display search results and pop up downloads.

When it is difficult to identify the product, there can be an example in which there is model information but two or more related search results, and an example in which the product identification is impossible.

In an example in which there is model information but two or more related search results are present, the user interface can be changed to the product instruction manual application, and the search results can be displayed.

In an example in which product identification is impossible, the user interface can be changed to the home of the product user manual application.

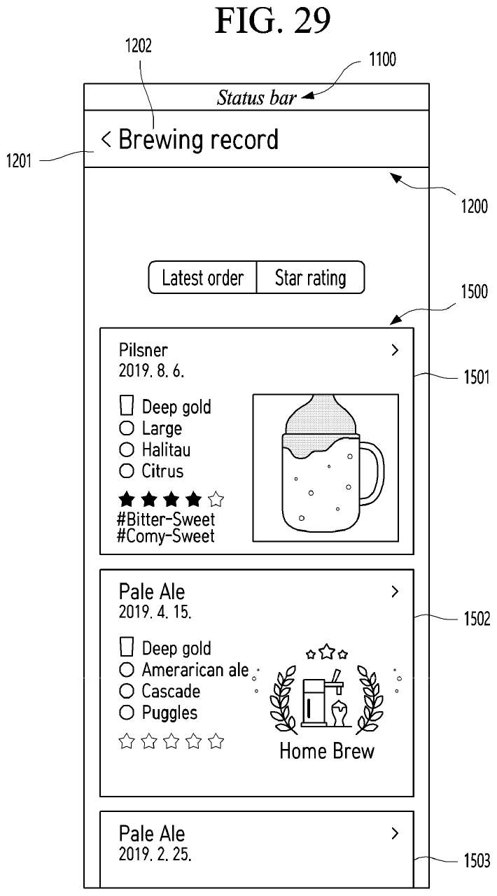

FIG. 29 is a view when the user interface displays the brewing record. FIG. 16 illustrates an example in which a record of beverages made by the beverage maker is displayed with a date.

When the user taps the ‘>’ icon 1403c of the brewing record card 1403 (see FIG. 15), the user interface can move to the brewing record as illustrated in FIG. 16.

The user interface can display a status bar area 1100, a title area 1200, and a list area 1500.

The status bar area 1100 can be the same as when the beverage maker is on standby.

A ‘<’ icon 1201 and a title 1202 such as ‘Brewing record’ can be displayed on the title area 1200.

At least one brewing record can be displayed on the list area 1500.

In the list area 1500, records of made beverage (i.e., brewing records) can be sorted by latest order or by star rating. For the sorting by the latest order and the star rating, the latest sorting can be set as default, and the tap can be rearranged according to the corresponding sorting.

The brewing record can be displayed as a brewing recipe card, and if there are multiple records of the made beverage, a plurality of brewing recipe cards can be displayed in order of the latest or star rating on the list area 1500.

The brewing recipe cards 1501, 1502, and 1503 can be displayed on the list area 1500.

Each of the brewing recipe cards 1501, 1502, and 1503 can display a recipe name and a tap of ‘>’ together, and when the user inputs a tap of ‘>’, the user interface can move to the detailed screen of the corresponding recipe.

A making completion date (year, month, and day) of the corresponding recipe can be displayed on each of the brewing recipe cards 1501, 1502, and 1503.

An emblem or image can be displayed on each of the brewing recipe cards 1501, 1502, and 1503. If an image is inputted, a basic emblem can be displayed, and if an image is not input, an emblem may not be displayed.

Capsule information can be displayed on each of the brewing recipe cards 1501, 1502, and 1503.

The star rating (x stars of 5 stars) can be displayed on each of the brewing recipe cards 1501, 1502, and 1503.

A beer style tag can be displayed on each of the brewing recipe cards 1501, 1502, and 1503. The beer style tag can be added by the user. A tag in the record can be displayed in a maximum of 2 lines, and a record exceeding the area can be processed as fade-out.

If there is no record of making the beverage, a guide message such as “There is no brewing record” can be displayed on the list area 1500.

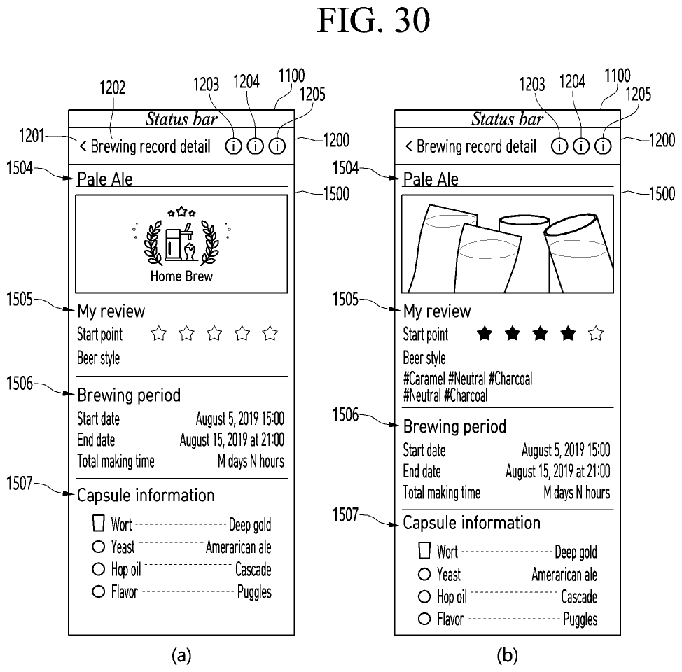

FIG. 30 is a view when the user interface displays brewing record details.

When any one 1502 of the plurality of brewing recipe cards 1501, 1502, and 1503 illustrated in FIG. 29 is inputted, the user interface can be converted to a screen displaying the brewing record details as illustrated in (a) of FIG. 30.

(a) of FIG. 30 is a view when the brewing recipe initially enters, and (b) of FIG. 30 is a view when the recipe name, the image, the star rating, or the tag are added/edited.

The user interface can provide a status bar area 1100, a title area 1200, and a list area 1500.

As illustrated in FIG. 30, the status bar area 1100 can be the same as the brewing record illustrated in FIG. 29, and a ‘<’ icon 1201 and a title 1202 such as ‘Brewing record details’ can be displayed on the title area 1200.

The list area 1500 can display the brewing record details.

The brewing record details can include a recipe name 1504, a my review 1505, a brewing period 1506, and capsule information 1507.

The recipe name 1504 can be set to a beer name as default can include a beer image, and if the beer image is not updated, the basic emblem can be provided as illustrated in (a) of FIG. 30.

The my review 1505 can be displayed with the star rating, and a default value can be 0.

The brewing period 1506 can be displayed with a start date, an end date, and a total making period, the start date can be a making start date, the end date can be a making end date, and the total manufacturing period can be a time taken for making.

The capsule information 1507 can include wort information, yeast information, hop oil information, and flavor or hop information.

The user can edit, share, or delete the brewing record details illustrated in (a) of FIG. 30 through the brewing record details displayed on the title area 1200 illustrated in (a) of FIG. 30.

At least one menu for accessing the edit, the share, and the delete can be displayed on the title area 1200.

The at least one menu can include an edit menu 1203 that is inputted by the user to edit the brewing record, a share menu 1204 that is inputted by the user to share the brewing record, and a delete menu 1205 that is inputted by the user to delete the brewing record.

When the user inputs the edit menu 1203, the share menu 1204, or the delete menu 1205 displayed on the title area 1200, the user interface can be converted to a screen for the input function.

In the brewing record details, the recipe name 1504, the my review 1505, and the capsule information 1507 can be edited.

The user can select the edit menu 1203 displayed on the title area 1200 and then input the edit menu, and the user interface can provide a screen for editing the brewing record.

The screen for editing the brewing record can include a keyboard screen, and the user can edit the beer name through a keyboard input and touch input.

The beer image of the recipe name 1504 can be updated/edited by taking a picture or using an existing picture.

The screen for editing the brewing record can display a menu for taking a picture and a menu for selecting a picture from an album, and a picture taken through the camera application can be uploaded as a beer image.

The star rating of the my review 1505 can be edited by the touch input.

The beer style of the my review 1505 can be edited by touch inputting the tag display.

The user can share the brewing record illustrated in (a) of FIG. 30 through the brewing record details displayed on the title area 1200 illustrated in (a) of FIG. 30.

The user can select the share menu 1204 displayed on the title area 1200 and then input the share menu, and the user interface can provide a screen for sharing the brewing records.

The user can delete the brewing record illustrated in (a) of FIG. 30 through the brewing record details displayed on the title area 1200 illustrated in (a) of FIG. 30.

The user can select the delete menu 1205 displayed on the title area 1200 and then input the delete menu, and the user interface can provide a screen for deleting the brewing record.

The brewing record in the expert mode or the mix and match mode can be edited by the user, and the user interface can provide a screen for editing the capsule information 1507.

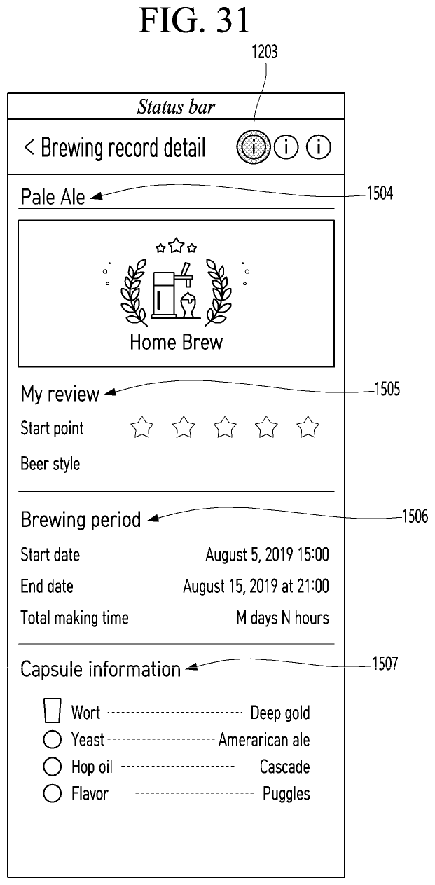

In expert mode or mix and match mode, if the user inputs the edit menu 1203 illustrated in (a) of FIG. 30, the user interface can display a brewing record edit screen as illustrated in FIGS. 31 to 35.

FIGS. 31 to 35 is a view when the user interface edits the brewing record in the expert mode.

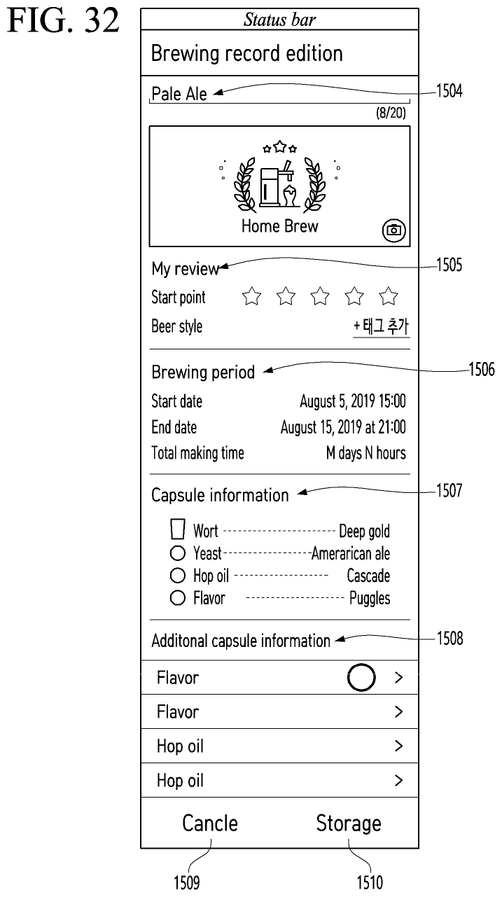

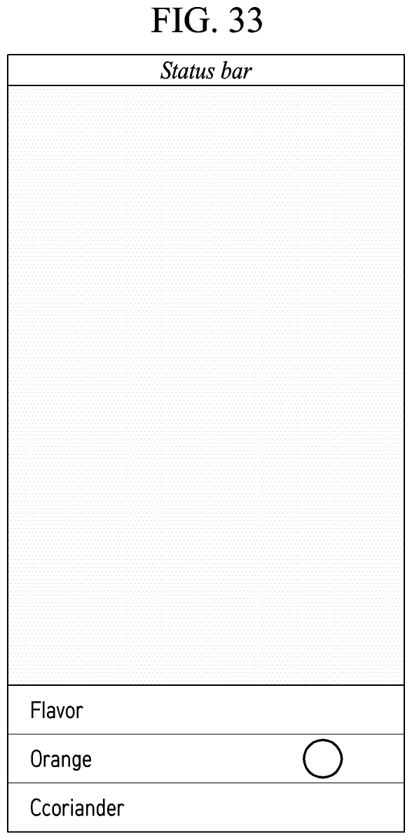

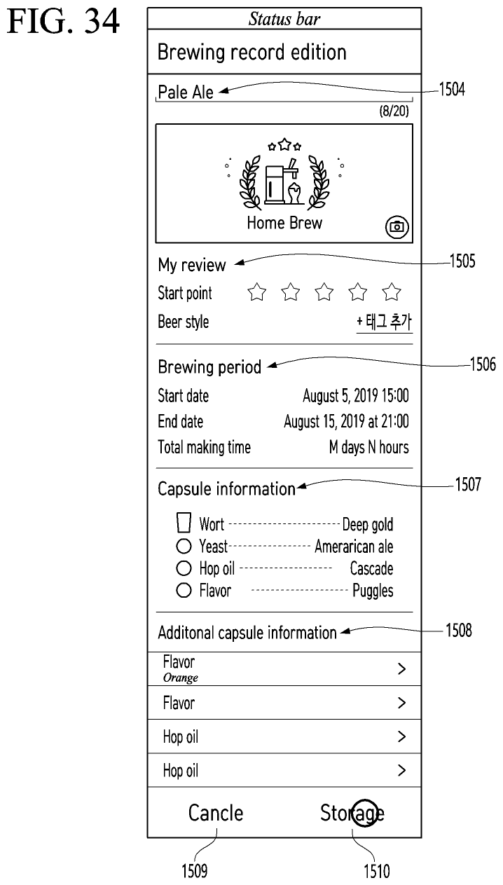

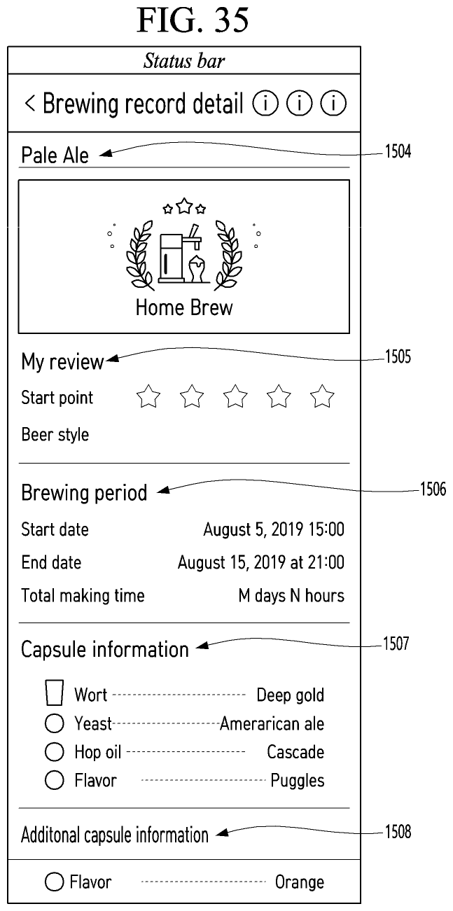

FIG. 31 is a view when the user interface provides the brewing record details in the expert mode, FIG. 32 is a view when the user interface provides the brewing record editing screen in the expert mode, FIG. 33 is a view when the user interface displays at least one flavor, and the user inputs the flavor, FIG. 34 is a view when the user interface provides the brewing record editing screen in the expert mode when the flavor is selected, and FIG. 35 is a view when the user interface provides the brewing record details when the selected flavor is stored.

The user can input the edit menu 1203 illustrated in FIG. 31, and the user interface can provide a screen for editing the brewing record in the expert mode as illustrated. 31.

The brewing record editing screen illustrated in FIG. 32 can include a recipe name 1504, a my review 1505, a brewing period 1506, and capsule information 1507, like the brewing record details and can further include additional capsule information 1508, a cancel button 1509, and a save button 1510.

As illustrated in FIG. 32, the additional capsule information 1508 can include at least one flavor button and at least one hop oil button.

If the user selects the flavor button from the additional capsule information 1508 illustrated in FIG. 32, the user interface can display an orange button and a coriander button as illustrated in FIG. 33, and when the user selects one of the orange button and the coriander button illustrated in FIG. 33, the user interface can provide the brewing record editing screen as illustrated in FIG. 34 again. The brewing record editing screen can be different from before the flavor selection and additional capsule information 1508.

The selected flavor (e.g., orange) can be displayed on the brewing record editing screen as illustrated in FIG. 34, and when the user can presses the save button provided on the brewing record edit screen as illustrated in FIG. 34, the selected flavor (e.g., orange) can be displayed on the additional capsule information 1508 of the brewing record details as illustrated in FIG. 35.

If the hop oil is selected from the additional capsule information 1508, goldings, citrus, chinook, cascade, puggles, hallertau, etc., and when the user selects one of the goldings, the citrus, the chinook, the cascade, the puggles, the hallertau and inputs the save button 1510, the selected hop oil can be displayed on the additional capsule information 1508.

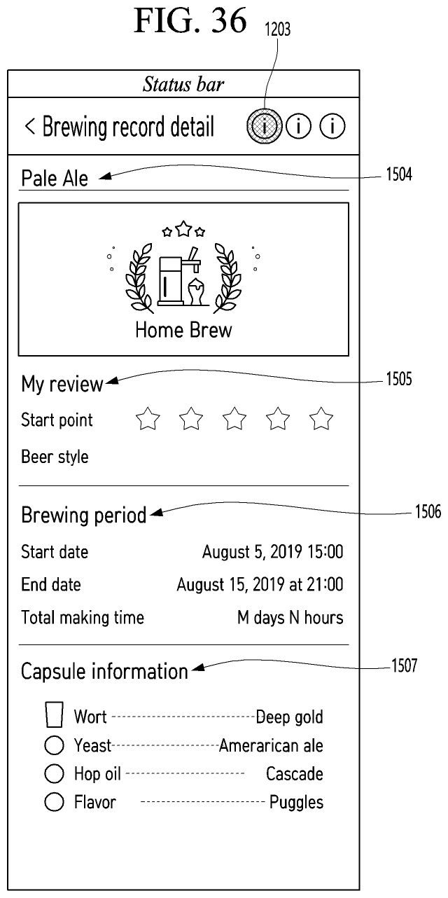

FIGS. 36 to 40 is a view when the user interface edits the brewing record in the mix and match mode.

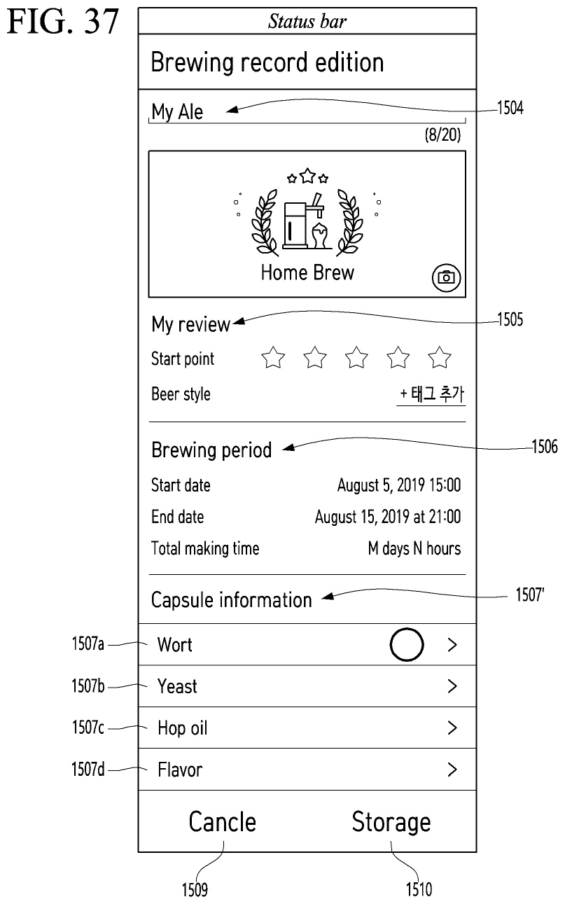

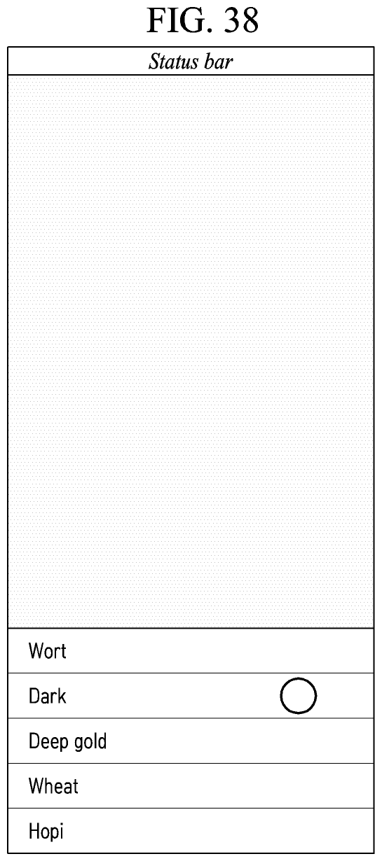

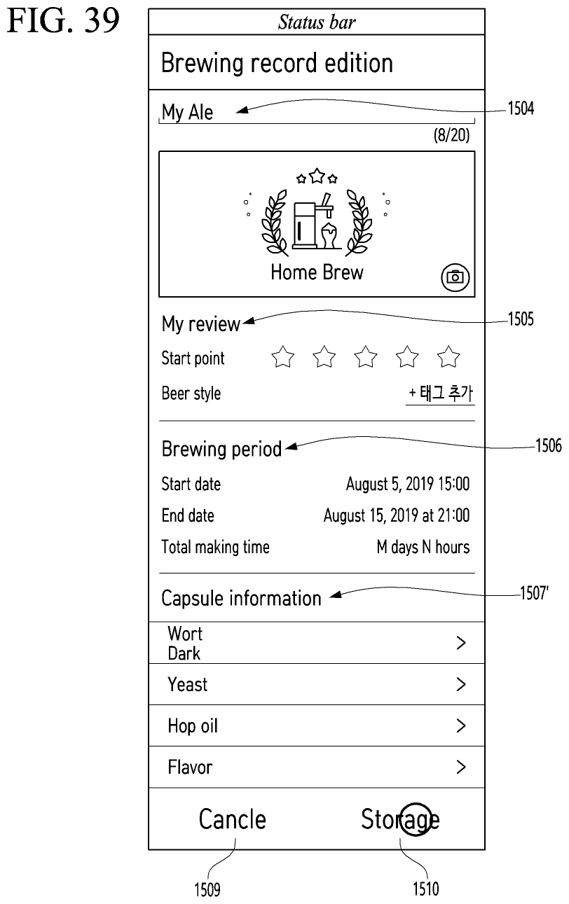

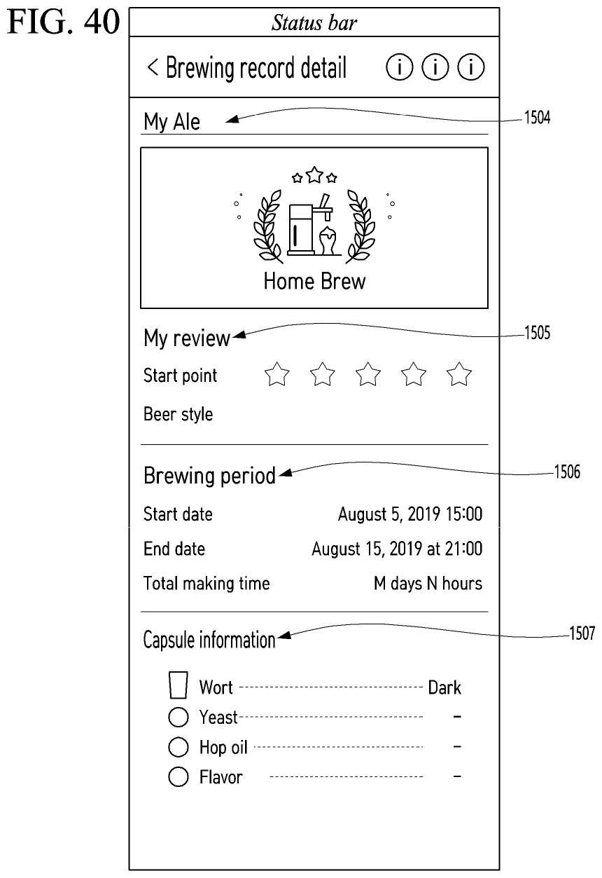

FIG. 36 is a view when the user interface provides the brewing record details in the mix and match mode, FIG. 37 is a view when the user interface provides the brewing record editing screen in the mix and match mode, FIG. 38 is a view when wort is selected from the capsule information, the user interface displays a plurality of worts, and the user inputs one of the plurality of worts, FIG. 39 is a view when the user interface provides the brewing record editing screen in the mix and match mode when the wort is selected, and FIG. 40 is a view when the user interface provides the brewing record details when the selected wort is stored.

The user can input the edit menu 1203 illustrated in FIG. 36, and the user interface can provide a screen for editing the brewing record in the mix and match mode as illustrated in FIG. 37.

The brewing record editing screen illustrated in FIG. 37 can include a recipe name 1504, a my review 1505, and a brewing period 1506, and can further include capsule editing information 1507′ capable of editing the capsule information 1507 illustrated in FIG. 36, a cancel button 1509, and a save button 1510.

As illustrated in FIG. 37, the capsule editing information 1507′ can include a wort button 1507a, a yeast button 1507b, a hop oil button 1507c, and a flavor button 1507d.

When the wort button 1507a is selected from the capsule editing information 1507′ illustrated in FIG. 37, the user interface can be changed to a screen for selecting one of the plurality of worts as illustrated in FIG. 38.

The plurality of worts can include dark, deep gold, wheat, and hopi, and when the user selects one (e.g., dark) among the dark, the deep gold, the wheat, and the hopi, the user interface can provide the brewing record editing screen displayed in FIG. 39 again. The brewing record editing screen can have different capsule editing information 1507′ from before the wort selection, as illustrated in FIG. 39.

The selected wort (e.g., dark) can be displayed on the brewing record editing screen as illustrated in FIG. 37, and when the user can presses the save button provided on the brewing record edit screen as illustrated in FIG. 39, the selected wort (e.g., dark) can be displayed on the capsule information 1507 of the brewing record details as illustrated in FIG. 40.

When the yeast button 1507b is selected from the capsule editing information 1507′ illustrated in FIG. 37, the user interface can be changed to a screen for selecting one of the plurality of yeasts.

The plurality of yeasts can include lager, weizen, american ale, english mail, and the like, and when the user selects one (the larger) of the lager, the weizen, the american ale, and the english mail, the user interface can provide the brewing record editing screen again. The brewing record editing screen can have different capsule editing information 1507′ from before the yeast selection.

The selected yeast (e.g., lager) can be displayed on the brewing record edit screen, and when the user enters the save button 1510 provided on the brewing record edit screen, the selected yeast (e.g., lager) can be displayed on the capsule information 1507 of the brewing record details.

When the hop oil button 1507c is selected from the capsule editing information 1507′ illustrated in FIG. 37, the user interface can be changed to a screen for selecting one of the plurality of hop oils.

The plurality of hop oils can include goldings, citrus, chinook, cascade, puggles, hallatau, and the like, and the user can select one of the goldings, the citrus, the chinook, the cascade, the puggles, and the hallertau (e.g., goldings), the user interface can provide the brewing record editing screen again. The brewing record editing screen can have different capsule editing information 1507′ from before the hop oil selection.

The selected hop oil (e.g., goldings) can be displayed on the brewing record edit screen, and when the user enters the save button 1510 provided on the brewing record edit screen, the selected hop oil (e.g., goldings) can be displayed on the capsule information 1507 of the brewing record details.

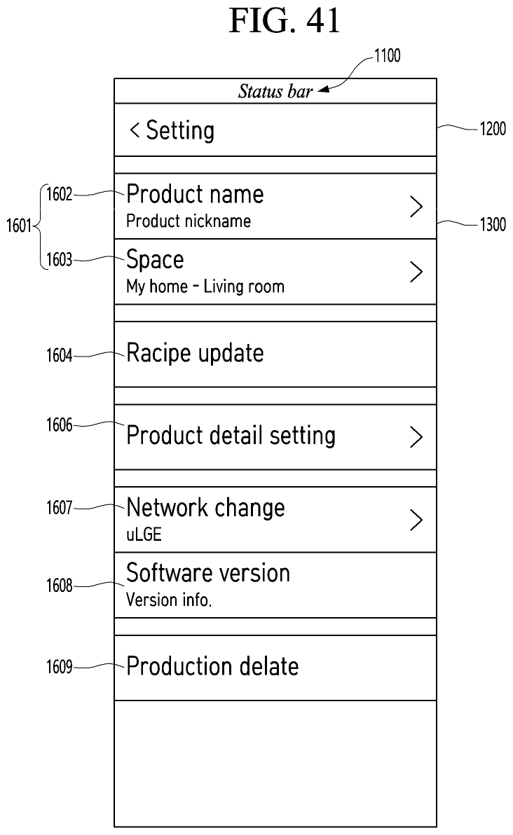

FIG. 41 is a view when the user interface displays setting.

The user interface can display a status bar area 1100, a title area 1200, and a main area 1300.

A phrase such as “status bar” can be displayed on the status bar area 1100.

An icon of ‘<’ and a phrase such as ‘setting’ can be displayed on the title area 1200.

A setting common function 1601 can be displayed on the main area 1300.

The setting common function 1601 can include a product name item 1602 and a space item 1603.

The product name 1602 can include a product name, a ‘>’ icon, and a product nickname.

A space 1603 can include a phrase such as space, a ‘>’ icon, and a room name such as my room-living room.

The main area 1300 can include a recipe update 1604.

The recipe update 1604 can be activated to be updated and can be activated if a registered product is on standby (updatable), when there is the update and can be deactivated otherwise. The recipe update 1604 can include a recipe update phrase and a ‘>’ icon, and when the user inputs the ‘>’ icon, the user interface can be converted to a screen for updating a recipe.

The main area 1300 can include product detailed setting 1606, network change 1607, software version 1608, and product deletion 1609.

The detailed product setting 1606 can include a text of detailed product settings and the ‘>’ icon, and when the user inputs the ‘>’ icon, the user interface can be converted to a screen for executing the detailed product setting.

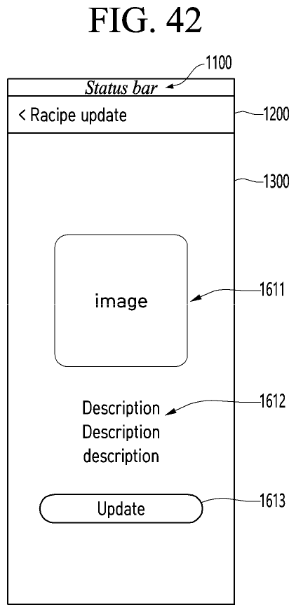

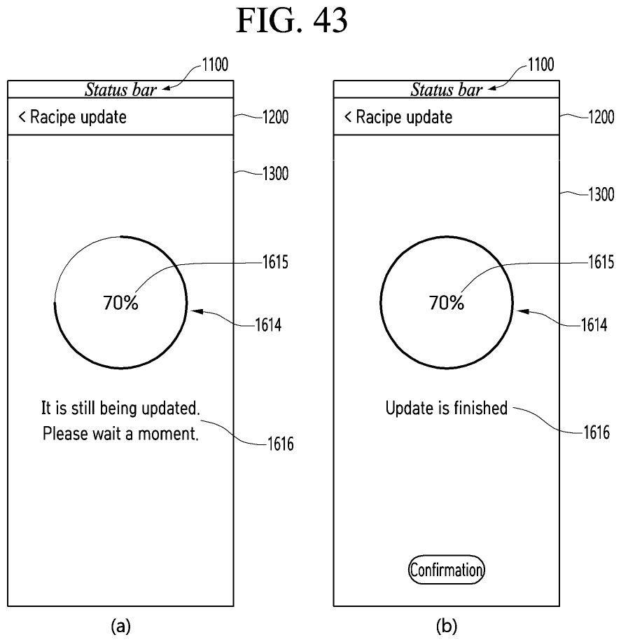

FIG. 42 is a view when the recipe update is inputted. FIG. 43 is a view when the recipe update is in progress.

When the user inputs the ‘>’ icon of the recipe update 1604 (see FIG. 41), the user interface can be converted to a screen for updating the recipe.

As illustrated in FIG. 42, the user interface can provide the screen for updating the recipe and can display a status bar area 1100, a title area 1200, and a main area 1300.

The title area 1200 can display a′<′ icon and a recipe update phrase.

The main area 1300 can include a recipe image 1611, a guide 1612, and an update button 1613.

When the user inputs the update button 1613, the main area 1300 of the user interface can display an animation 1614 as illustrated in FIG. 43, an update progress number 1615 displayed as a percentage, and a text 1616 of an update progress status.

The text of the update progress status 616 can be displayed on the main area 1300 and can include progress/complete/failure.

An example of progress text can be a text such as “It is still being updated. Please wait a moment.” as illustrated in (a) of FIG. 43.

As illustrated in (b) of FIG. 43, an example of the completion text can include a text such as “Update is finished” and a confirmation button.

An example of the failure text can include text such as “Failed to complete the update. Please try again” and a confirmation button.

An update popup can occur when the beverage maker with the recipe update is on standby, and an update popup can not occur when the beverage maker is in progress of the homebrew.

The update popup can include a guide phrase such as “Recipe information has changed. Try updating the recipe,” a later button, and an update button.

When the user presses the update button, the user interface can provide the screen for updating the recipe as illustrated in FIG. 42.

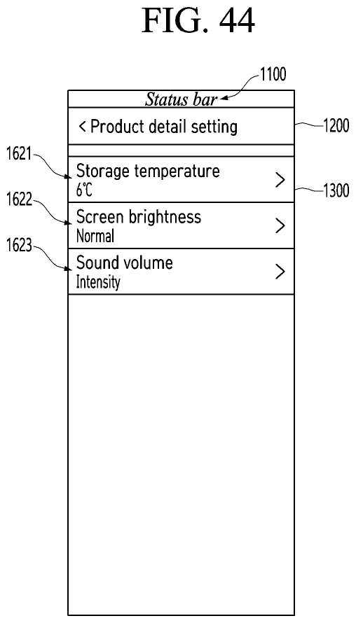

FIG. 44 is a view when the detailed product setting is inputted.

When the user inputs the ‘>’ icon of product detailed setting 1606 (see FIG. 41), the user interface can be converted to a screen for product detailed setting.

The user interface can display a status bar area 1100, a title area 1200, and a main area 1300.

A ‘<’ icon and a phrase such as the detailed product setting can be displayed on the title area 1200.

The main area 1300 can display a storage temperature item 1621, and the storage temperature item 1621 can include a storage temperature (4 degrees/6 degrees) and a ‘>’ icon. About 6 degrees can be set as default.

When the user inputs the ‘>’ icon of the storage temperature item 1621, the user interface can be changed to a screen for selecting a temperature, a 4-degree storage temperature button and a 6-degree storage temperature button can be displayed, and the user can select about 4 degrees or about 6 degrees.

The main area 1300 can display a screen brightness item 1622. The screen brightness item 1482 can be an item for setting screen brightness of the product device, and the screen brightness item 1621 can include screen brightness (bright/normal/dark) and a ‘>’ icon. The screen brightness can be set to brightness of about 100%/normal 50%/dark 20%. The normal brightness can be set as default.

When the user inputs the ‘>’ icon of the screen brightness item 1482, the user interface can be changed to a screen on which the screen brightness is selected to display a bright button, a normal button, and a dark button, and thus, the user can select one of light, normal, and dark.

The main area 1300 can display a volume item 1623, and the volume item 1623 can be an item for setting an intensity of a product system beep sound and include a volume item 1623 and a ‘>’ of a sound volume (high/low/mute). The volume can be set to the ‘high/low/mute’. The ‘high’ can be set as default.

If the user inputs the ‘>’ icon of the volume item 1483, the user interface can be changed to a screen for selecting the volume to display a high button, a low button, and a mute button, and thus, the user can set the volume to one of the high, low, and mute.

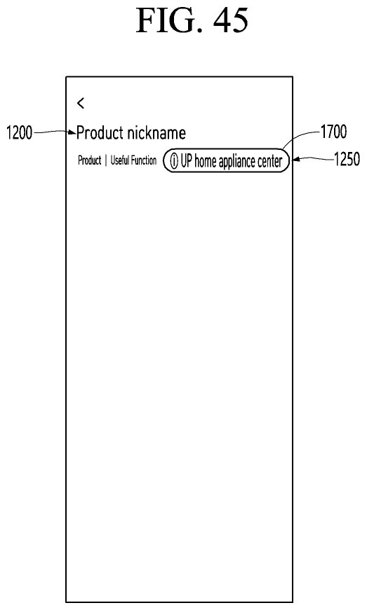

FIG. 45 is a view when the user interface displays that there is the upgrade item.

When there is the upgrade item, the user interface can provide a phrase such as ‘product/useful function’ along with an upgrade button 1700 on the tab bar of the tab area 1250.

The upgrade button 1700 can include a phrase such as an UP home appliance center.

When the user presses the upgrade button 1700, the user interface can provide an upgrade screen.

When there is no upgrade item, the user interface can provide a phrase such as ‘product/useful function’ and a basic button on the tab bar of the tab area 1250.

FIG. 45 is a view illustrating an example in which the user interface is connected to the UP home appliance center.

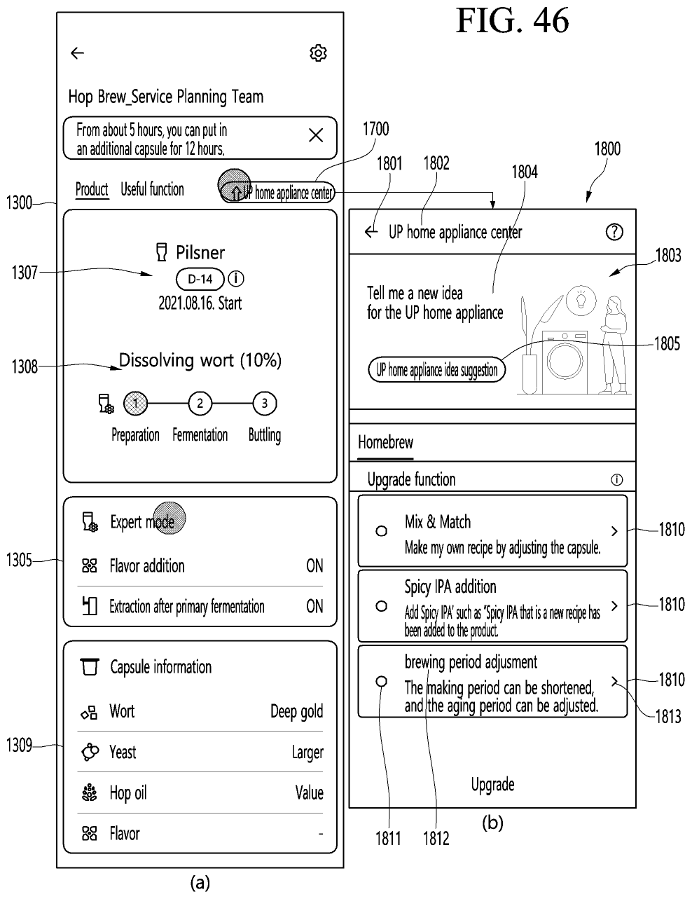

(a) of FIG. 46 is a view illustrating the user interface when the expert mode is being prepared, and (b) of FIG. 46 is a view illustrating the user interface when the upgrade button 1700 illustrated in (a) of FIG. 46 is inputted.

The user can execute the flavor addition and the extraction after the primary fermentation according to turning on/off the expert mode card 1305 illustrated in (a) of FIG. 46 and can select the a storage temperature of about 4 degrees or about 6 degrees to diversify the storage temperature setting.

When the user inputs the upgrade button 1700 illustrated in (a) of FIG. 46, the user interface can provide an upgrade screen 1800 as illustrated in (b) of FIG. 46.

The upgrade screen 1800 can include a icon 1801 and a phrase 1802 such as the ‘UP home appliance center’.

The upgrade screen 1800 can include an upgrade suggestion area 1803 capable of suggesting an upgrade.

The upgrade suggestion area 1803 can include a guide text 1804 describing the upgrade suggestion area 1803, such as “Tell me a new idea for the UP home appliance,” and an idea suggestion button 1805 which is pressed by the user during the “UP home appliance idea suggestion.”

The upgrade screen 1800 can further include an upgrade selection area 1810 for selecting the examples of the upgrade.

A plurality of upgrade selection areas 1810 can be provided. A plurality of upgrade selection areas 1810 can be arranged in a line in a vertical direction.

The upgrade selection area 1810 can include an icon 1811 of ‘°’, a phrase 1812 describing an upgrade target, such as ‘Mix & Match’, ‘Add Spicy IPA’, or ‘Brewing period condition’, and a ‘>’ icon 1813.

A guide phrase explaining ‘Mix & Match’ such as “Make my own recipe by adjusting the capsule” can be displayed around the phrase ‘Mix & Match’.

A guide phrase explaining ‘Add Spicy IPA’ such as “Spicy IPA that is a new recipe has been added to the product” can be displayed around the phrase ‘Add Spicy IPA’.

A guide phrase describing the ‘brewing period condition’ such as “The making period can be shortened, and the aging period can be adjusted.” can be displayed around the phrase ‘brewing period condition’.

A user can input a >′ icon 1813 of a desired upgrade among the plurality of upgrade selection areas 1810, and the user interface can be changed to an upgrade screen.

The beverage making system can respond and implement the product upgrades (i.e., UP home appliance functions) at each stage through the user interface.

The Mix & Match can make 1,024 types of beverages when there are 4 types of worts, 4 types of yeasts, and 8 types of flavors.

In addition, in 1,024 types of beverages, the manufacturer can recommend, for instance, 16 types of beverages. Examples of the 16 beverages can be Session IPA, Bavarian Weissbier, California Common, Dark Ale, Indian Pale Lager, Munich Helles, American Pale Lager, Session Summer Ale, Citrus Ale, Belgian Wit Lager, Red Lager, Golden Ale, American Porter, Hoppy IPA, Bayerische Dunkel, and Weissbier Hell.

The beverage making system can add a new recipe, adjust the aging period by changing the brewing period conditions, and shorten the making time.

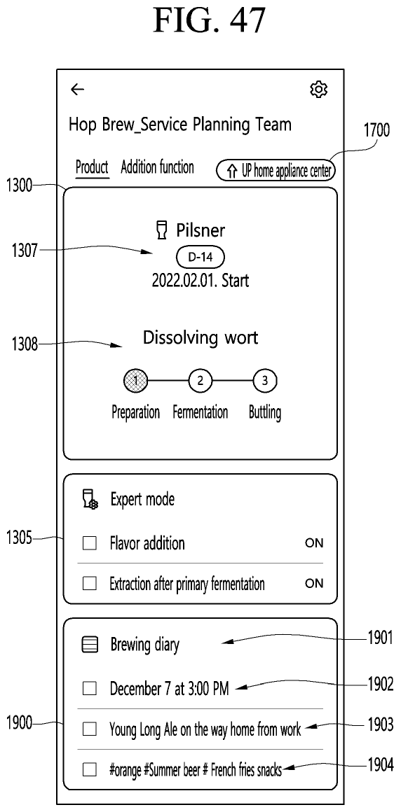

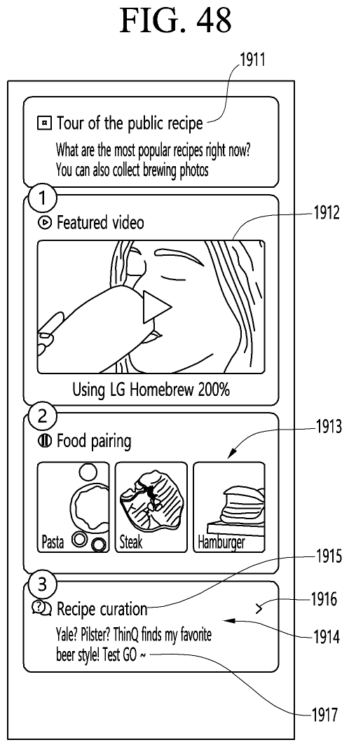

FIG. 47 is a view when the user interface displays the brewing record, and FIG. 48 is a view illustrating the user interface when a brewing diary illustrated in FIG. 47 is inputted.

The user interface can provide a brewing diary card 1900 on the main area 1300. The brewing diary card 1900 can be provided with at least one brewing information 1307 and 1308, an expert mode card 1305, and an upgrade button 1700.

The brewing diary card 1900 can include a title 1901, a brew time 1902, a brewing name or nickname 1903, and a brewing summary 1904.

An example of the title 1901 can be a brewing diary.

As an example of the brewed time 1902, the brewed time can be expressed as a month, a day, and an hour, such as December 7 at 3:00 PM.

An example of the brewing name or nickname 1903 can be Young Long Ale on the way home from work.

An example of the brewing summary 1904 can be a text associated with a brewed beverage, such as orange, summer beer, French fries snack, and the like.

The user can input the brewing summary 1904, and when the user inputs the brewing summary 1904, the user interface can display a screen related to the brewing summary 1904.

As illustrated in FIG. 48, the screen related to the brewing summary 1904 can display a tour of the public recipe 1911 associated with the brewing summary 1904, recommended video information 1912, food pairing 1913, and recipe curation 1914.

The user can use the recommended video information 1912 to utilize product usage guides and usage tips (official channel contents) or actual user reviews.

The food pairing 1913 can utilize snack recipes or pairing-related manufacturers' contracts and can support connection between products (oven/range/beverage maker).

The recipe curation 1914 can include a title 1915, a ‘>’ icon 1916, and a guide text 1917.

An example of the title 1915 can be “curation of recipe.”

An example of the guide text 1917 can be “Yale? Pilster? ThinQ finds my favorite beer style! Test GO˜.”

The recipe curation 1914 can perform a curation function of suggesting a homebrew recipe of a customer's preference and can be implemented in a user-friendly manner.

The user interface can provide a plurality of diary lists on one screen, and when each diary list is inputted, details of the diary list can be inputted and displayed as an open recipe list. In this case, a diary function using note recording or hashtags can be installed, and the convenience of repurchasing capsules/recipe reselection can be provided. In addition, the user of the beverage maker can communicate while sharing this information (public recipe) with each other. The beverage making system can provide a fun factor, such as viewing a collection of recipes or photos with a high number of recommendations to the user.

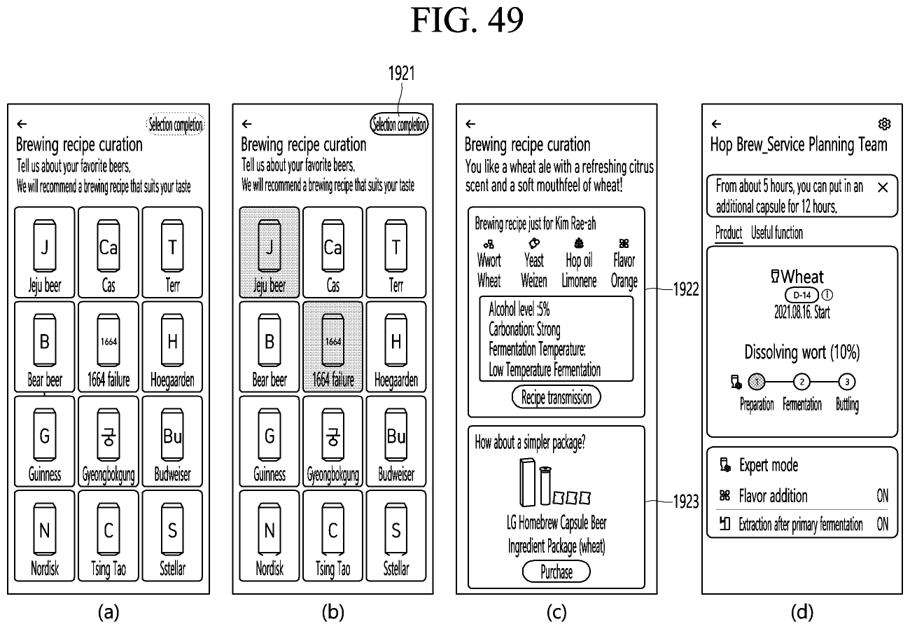

FIG. 49 is a view illustrating the capsule curation.

The user interface can provide brewing recipe curation information. As illustrated in (a) of FIG. 49, the user interface can display various beverages with names, and when the user inputs a specific beverage as illustrated in (b) of FIG. 49 and presses the selection completion button 1921, the user interface can display an area 1922 for starting the recommended recipe and an area 1923 for helping to purchase a recommended package, as illustrated in (c) of FIG. 49.

The user interface can display a beverage selected by the user and related to the recommended recipe as illustrated in (d) of FIG. 49.

In this case, the beverage making system can implement a customer-friendly approach by matching the recipe/capsule to the finished product.

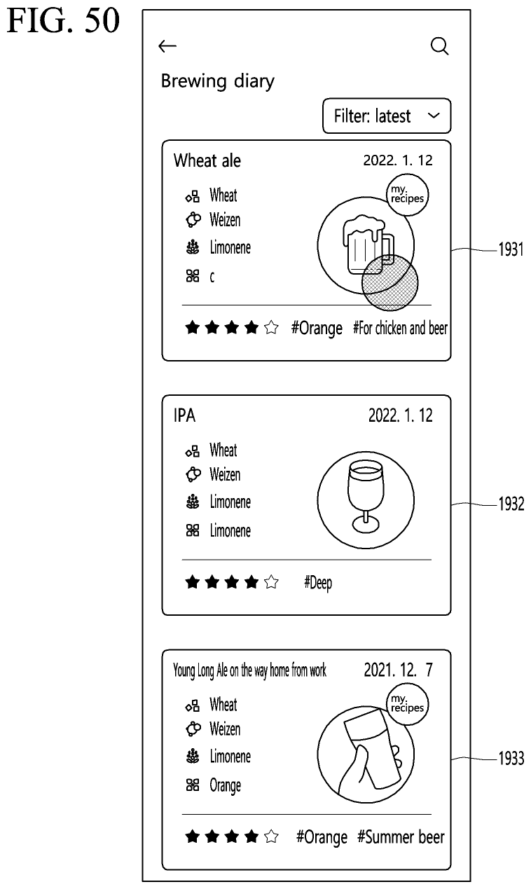

FIGS. 50 to 52 is a view illustrating an example of a flow of the brewing record.

FIGS. 50 to 52 illustrates an example of a basic capsule package.

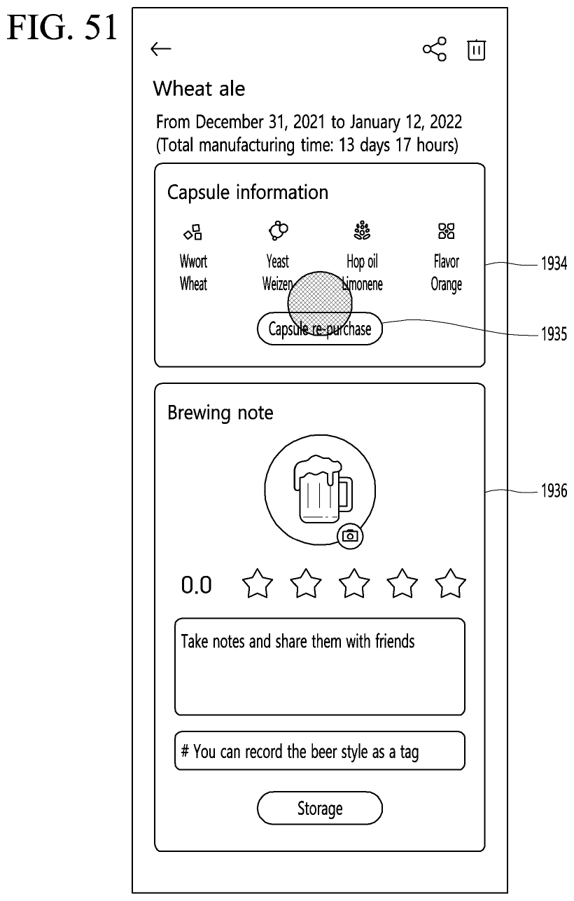

As illustrated in FIG. 50, the user interface can display a plurality of brewing records 1931, 1932, and 1933. If one of the plurality of brewing records 1931, 1932, and 1933 is inputted, the user interface can be changed to a detailed screen displaying details of the selected brewing record, as illustrated in FIG. 51.

The detailed screen can include capsule information 1934 and brewing notes 1936.

The capsule information 1934 can display names of capsules used for brewing by type of capsules (yeast, hop oil/flavor) and can include a repurchase button 1935.

The brewing note 1936 can include a star mark to which a star point is inputted and a note to which the user inputs information related to the brewing.

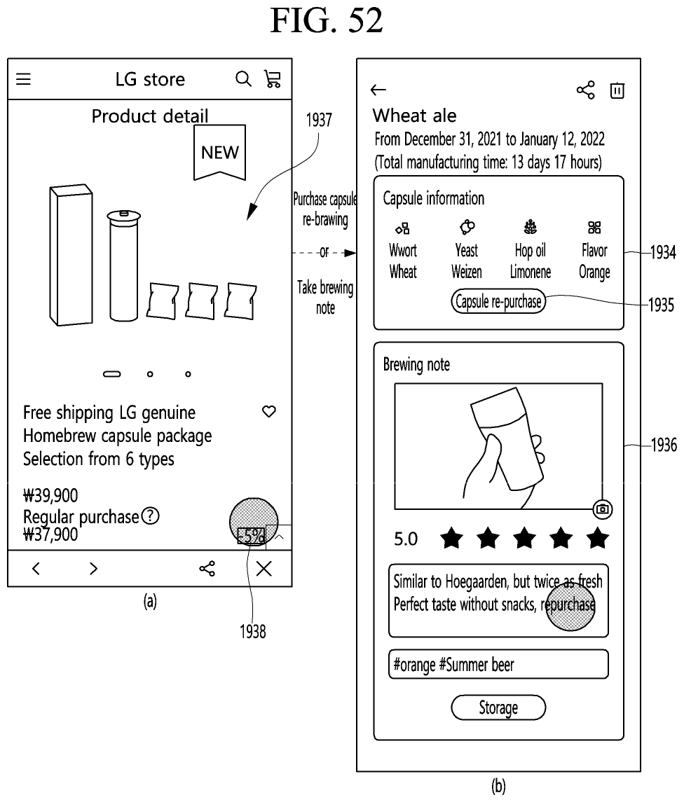

When the user inputs the repurchase button 1935, the user interface can provide a capsule purchase site or a capsule purchase screen on which the capsules contained in the capsule information 1934 are ordered, as illustrated in (a) of FIG. 52.

The capsule purchase site or capsule purchase screen can include a price of a capsule package to be purchased and a purchase button 1938.

When the user inputs the purchase button 1938, re-brews the purchased capsule package or writes a brewing note, the user interface can display the capsule information 1934 and the brewing note 1936 as illustrated in (b) of FIG. 52.

The capsule information 1934 can display information on capsules purchased by the user, and the brewing notes 1936 can display content created by the user.

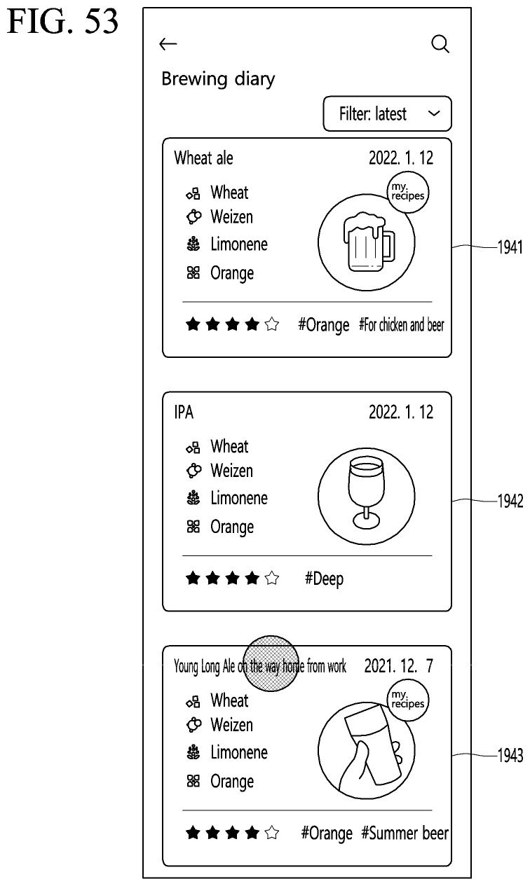

FIGS. 53 to 55 is a view illustrating another example of the flow of the brewing record.

FIGS. 53 to 55 illustrates a case of the mix and match (my recipe).

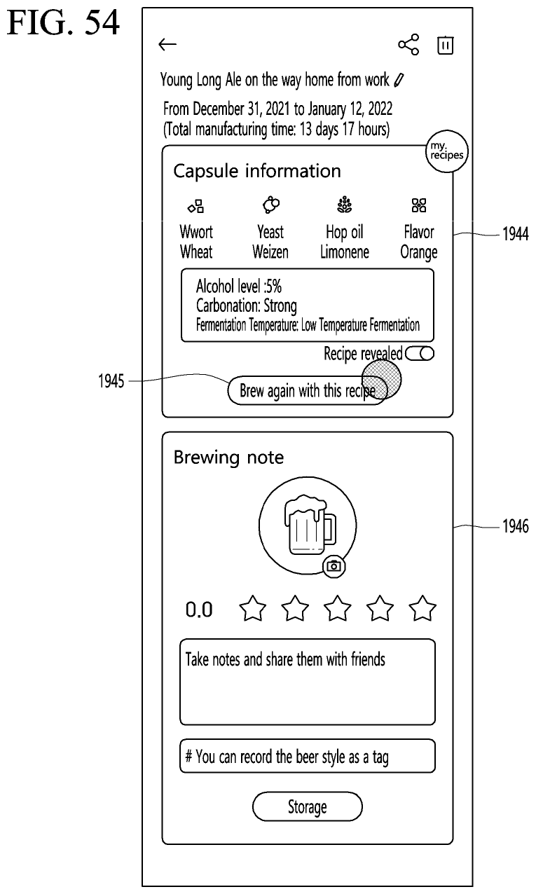

As illustrated in FIG. 53, the user interface can display a plurality of brewing notes 1941, 1942, and 1943. If one (e.g., the Young Long Ale on the way home from work) of the plurality of brewing notes 1931, 1932, and 1933 is inputted, the user interface can be changed to a detailed screen displaying details of the selected brewing note, as illustrated in FIG. 54.

The detailed screen can include capsule information 1944 and brewing notes 1936.

The capsule information 1944 can display names of capsules used for brewing by type of capsules (yeast, hop oil/flavor) and a recipe, and can include brew button 1945 with this recipe again.

The brewing note 1946 can include a star mark to which a star point is inputted and a note to which the user inputs information related to the brewing.

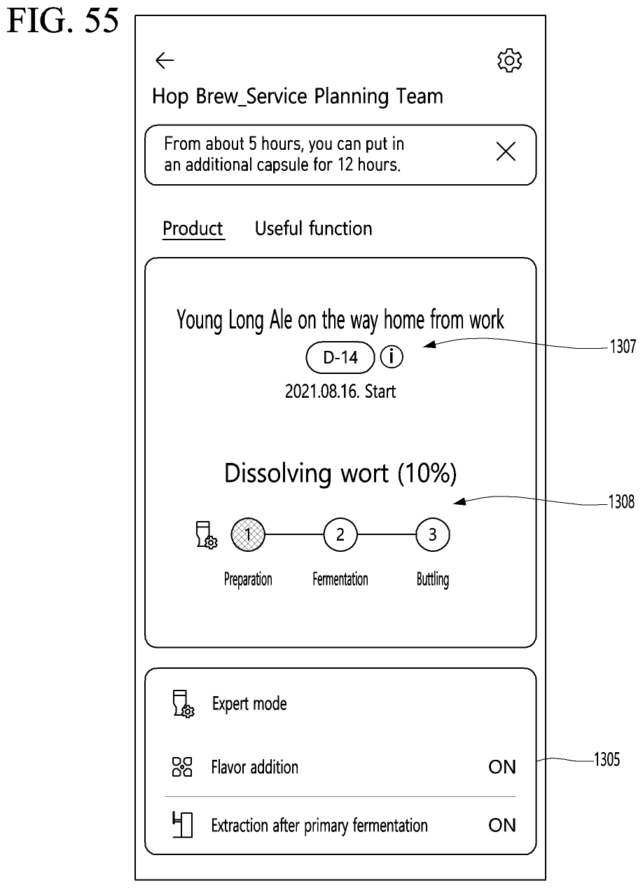

When the user presses the brow button 1945 again with this recipe, the user interface can display at least one brewing information 1307 and 1308 and an expert mode card 1305 as illustrated in FIG. 55.

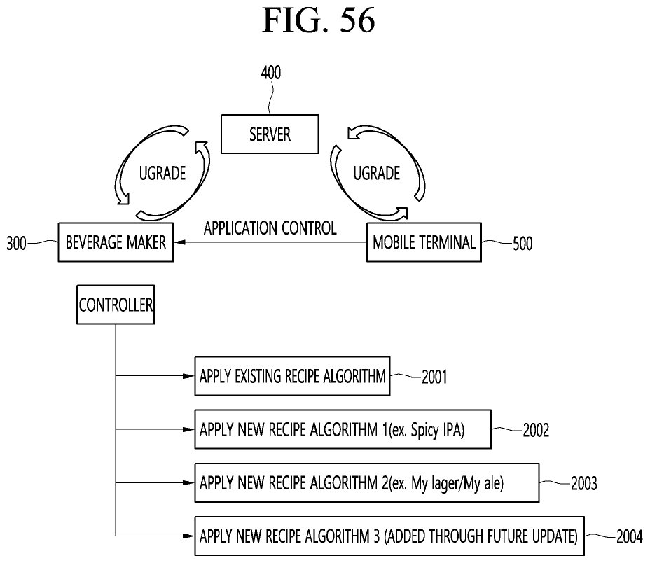

FIG. 56 is a view illustrating the beverage making system.

In the beverage maker 300, the server 400, and the mobile terminal 500, which constitute the beverage making system, the beverage maker 300 and the server 400 can be mutually upgraded, and the server 400 and the mobile terminal 500 can be mutually upgraded. In addition, the mobile terminal 500 can control the beverage maker 300 through an application control.

The beverage manufacturing system can apply a new algorithm by updating through the server 400 whether the mobile terminal 500 (ThinQ application) or the beverage maker 300, and the controller can apply the control algorithms 2001, 2002, 2003, and 2004, and the control algorithms 2001, 2002, 2003, and 2004 can have different fermentation temperature/time/pressure for each control algorithm.

The mobile terminal 500, the server 400, and the beverage maker 300 can control and upgrade the beverage maker 300 through the mobile terminal 500, and the beverage maker 300 can selectively perform a first mode in which a beverage is made with an existing recipe algorithm (normal mode), a second mode in which a beverage is made with a first new recipe algorithm (mix and match mode, e.g., Spicy IPA), a third mode in which a beverage is made with a second new recipe algorithm (mix and match, e.g., my larger/my ale), and a fourth mode in which a beverage is made with a third new recipe algorithm (added through future updates), and thus, the beverage making system can made more various beverages.

According to the implementations, a function of allowing the user to be involved in manufacturing the beverage can be added by the mix and match mode or the expert mode, and the degree of freedom of the customer can be improved to increase in interest in the beverage maker for the product.

In addition, the mover various kinds of beverages can be made by the mix and match mode.

In addition, when the expert mode is selected, and the fermentation ingredient can be extracted in the beverage maker and is stored in the container, the time taken to make the beverage by the beverage maker can be minimized, and the user can made a large amount of beverage through the beverage maker.

The above-disclosed subject matter is to be considered illustrative, and not restrictive, and the appended claims are intended to cover all such modifications, enhancements, and other implementations, which fall within the true spirit and scope of the present disclosure.

Thus, the implementations described above are to be considered illustrative, and not restrictive, and the technical spirit of the present disclosure is not limited to the foregoing implementations.

Therefore, the scope of the present disclosure is defined not by the detailed description of the disclosure but by the appended claims, and all differences within the scope will be construed as being included in the present disclosure.

What is claimed is:

1. A beverage making system comprising:
a mobile terminal;
a beverage maker configured to (i) communicate with at least one of the mobile terminal or a server, (ii) receive an upgrade item from the mobile terminal or the server, and (iii) make a beverage in a mode of a plurality of modes;
a user interface disposed at at least one of the mobile terminal or the beverage maker, configured to (i) display beverage making information, and (ii) receive a user's command; and
a controller configured to control the beverage maker according to an input from the user interface,
wherein the plurality of modes comprises:
a normal mode configured to make the beverage using a predetermined ingredient, and store the made beverage in the beverage maker, and
an upgrade mode configured to update the beverage making system by the mobile terminal or the server.

2. The beverage making system according to claim 1, wherein, based on the beverage making system being in the upgrade mode, at least one of a fermentation temperature, a fermentation time, or a fermentation pressure is different from when the beverage making system is in the normal mode.

3. The beverage making system according to claim 1, wherein the upgrade mode comprises a mix and match mode configured to make the beverage using an ingredient selected by a user, and store the made beverage in the beverage maker.

4. The beverage making system according to claim 3, the beverage maker is configured to, based on the beverage making system being in the mix and match mode, make a plurality of beverages, wherein making periods and fermentation temperatures of the plurality of beverages are different from each other.

5. The beverage making system according to claim 3, wherein the user interface is configured to display a first beverage name in the normal mode and a second beverage name in the mix and match mode.

6. The beverage making system according to claim 1, wherein the plurality of modes further comprises an expert mode configure to (i) ferment the predetermined ingredient, (ii) extract the fermented ingredient from the beverage maker, and (iii) store the fermented ingredient in a separate container.

7. The beverage making system according to claim 6, wherein the user interface is configured to, based on the beverage making system being in the expert mode, display an expert mode card comprising a set state of the expert mode.

8. The beverage making system according to claim 7, wherein the set state of the expert mode comprises (i) addition of flavor and (ii) extraction of the made beverage after primary fermentation.

9. The beverage making system according to claim 6, wherein a beverage making time in the expert mode is less than a beverage making time in the normal mode.

10. The beverage making system according to claim 1, wherein the user interface is configured to display product and function information.

11. The beverage making system according to claim 1, wherein the beverage maker comprises:
a fermentation module configured to ferment the beverage;
a temperature controller configured to control an inner temperature of the fermentation module;
a water supply module configured to supply water to the beverage maker;
an ingredient supplier configured to accommodate one or more ingredients for making the beverage; and
a beverage dispenser configured to dispense the made beverage from the fermentation module to an outside of the beverage maker.

12. The beverage making system according to claim 11, wherein the fermentation module comprises:
a fermentation tank module having an opening; and
a fermentation lid configured to open and close the opening of the fermentation tank.

13. The beverage making system according to claim 12, wherein the fermentation tank comprises a fermentation container that is disposed in the fermentation tank.

14. The beverage making system according to claim 11, wherein the temperature controller comprises:
a refrigerant cycle device configured to control the temperature of the fermentation tank; and
a heater configured to provide heat to the fermentation tank.

14. The beverage making system according to claim 11, wherein the ingredient supplier is configured to supply the one or more ingredients to a fermentation container with the water supplied from the water supply module.

15. The beverage making system according to claim 11, wherein the ingredient supplier comprises an ingredient accommodation portion, wherein the one or more ingredients are each accommodated in a capsule, and wherein each capsule is accommodated in the ingredient accommodation portion.

16. The beverage making system according to claim 11, further comprising:
a first main channel configured to couple the water supply module to the ingredient supplier;
a second main channel configured to couple the ingredient supplier to the fermentation module; and
a bypass channel,
wherein one end of the bypass channel is coupled to the first main channel and the other end of the bypass channel is coupled to the second main channel.

17. The beverage making system according to claim 16, wherein the beverage dispenser comprises:
a dispenser configured to dispense the beverage; and
a beverage dispensing channel configured to couple the dispenser to the second main channel.

18. The beverage making system according to claim 17, wherein the beverage dispenser further comprises a tab configured to open and close the dispenser and disposed at the dispenser.

19. The beverage making system according to claim 17, wherein the beverage dispensing channel comprises a beverage dispending valve configured to open and close the beverage dispensing channel.
